(19) United States
(12) Patent Application Publication
(10) Pub. No.: US 2024/0188593 A1
(43) Pub. Date: Jun. 13, 2024

(54) SENSORY MODIFIERS FOR EFFERVESCENT COMPOSITIONS

(71) Applicant: CARGILL, INCORPORATED, Wayzata, MN (US)

(72) Inventors: Isaak BROTT, Loretto, MN (US); Regina DRAPER, Minnetonka, MN (US); Imad EL RAFEI, Maple Grove, MN (US); Mark FAHLIN, St. Louis Park, MN (US); Rama Krishna SARANGAPANI, St. Michael, MN (US); Wade Nolan SCHMELZER, St. Louis Park, MN (US)

(73) Assignee: CARGILL, INCORPORATED, Wayzata, MN (US)

(21) Appl. No.: 18/549,337

(22) PCT Filed: Mar. 8, 2022
(86) PCT No.: PCT/US2022/071025

§ 371 Date: Sep. 6, 2023

Related U.S. Application Data
(60) Provisional application No. 63/158,527, filed on Mar. 9, 2021.
(60) Provisional application No. 63/158,786, filed on Mar. 9, 2021.
(60) Provisional application No. 63/187,572, filed on May 12, 2021.

(51) Int. Cl. A23L 2/40; A23C 11/02; A23F 5/46; A23L 2/56; A23L 2/60; A23L 2/68; A23L 27/00

(52) U.S. Cl. CPC A23L 2/40; A23C 11/02; A23F 5/465; A23L 2/56; A23L 2/60; A23L 2/68; A23L 27/84

(57) ABSTRACT

An effervescent composition having an effervescent agent, comprising an acid and a base, and a sensory modifier, such that when the effervescent composition is added to an aqueous solution, saltiness of the aqueous solution is reduced relative to saltiness of the aqueous solution when an equivalent effervescent composition lacking the sensory modifier is added.

### CROSS-REFERENCE TO RELATED APPLICATIONS

This application claims the benefit of U.S. Provisional Application No. 63/158,527, filed Mar. 9, 2021, U.S. Provisional Application No. 63/158,786, filed Mar. 9, 2021, and U.S. Provisional Application No. 63/187,572, filed May 12, 2021, each of which is incorporated herein by reference in its entirety.

### BACKGROUND

Effervescent tablets and powders are commonly used by consumers for a variety of applications. However, in some cases, consumers may discern that the sensory and temporal taste profile of beverages prepared with effervescent tablets and powders differ from similar beverages without an effervescent component. For example, beverages prepared from effervescent tables and powders may have increased saltiness, increased bitterness, and/or unfamiliar sensory attributes, such as astringency and metallic tastes. These sensory attributes can limit consumers preferences for these products and limit the applications of effervescent compositions.

### SUMMARY

The present disclosure provides compositions containing an effervescent agent and a sensory modifier. The effervescent agent comprises an acid and a base. The sensory modifier comprises a dicaffeoylquinic acid or salt thereof and one or more compounds selected from the group consisting of monocaffeoylquinic acids, monoferuloylquinic acids, diferuloylquinic acids, monocoumaroylquinic acids, dicoumaroylquinic acids, and salts thereof. When the composition is added in water or an aqueous solution, saltiness of the resulting solution is reduced relative to saltiness of an aqueous solution prepared with an equivalent composition lacking the sensory modifier. When the composition is added in water, a saltiness intensity value of the resulting solution is reduced by at least 1 unit, at least 2 units, at least 3 units, at least 4 units, or at least 5 units relative to a saltiness intensity value of an aqueous solution prepared with an equivalent composition lacking the sensory modifier, wherein saltiness intensity value is measured by the Standardized Saltiness Intensity Test.

The composition can be in the form of a tablet, a cube, or a powder. The composition can comprise at least 20% (wt), at least 30% (wt), at least 40% (wt), at least 45% (wt), or at least 50% (wt) of the effervescent agent. The composition can comprise between 20%-70% (wt), between 30%-65% (wt), or between 40%-60% (wt) of the effervescent agent. The effervescent agent can comprise a 0.25:1 to 3:1 ratio of acid to base. The base of the effervescent agent can be selected from the group consisting of potassium bicarbonate, sodium bicarbonate, sodium carbonate, sodium sesquicarbonate, potassium carbonate, magnesium carbonate, calcium carbonate, and combinations thereof. The acid of the effervescent agent can be selected form the group consisting of citric acid, aspartic acid, malic acid, adipic acid, tartaric acid, fumaric acid, succinic acid, sodium acid pyrophosphate, lactic acid, hexamic acid, amino acid hydrochlorides, acid salts thereof, acid anhydrides thereof, and combinations thereof.

The sensory modifier can be at least 1% (wt), at least 2% (wt), at least 3% (wt), at least 4% (wt), at least 5% (wt), at least 6% (wt), at least 7% (wt), or at least 8% (wt) of the composition. The sensory modifier can be 1%-10% (wt), 2%-8% (wt), or 3%-6% (wt) of the composition. The dicaffeoylquinic acid or dicaffeoylquinic salt can comprise at least one compound selected from the group consisting of 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, 4,5-dicaffeoylquinic acid, and salts thereof. The total of all dicaffeoylquinic acids and dicaffeoylquinic salts present in the sensory modifier can comprise 10% (wt) or more, 15 wt % or more, 20% (wt) or more, 25% (wt) or more, 30% (wt) or more, 35% (wt) or more, 40% (wt) or more, 45% (wt) or more, 50% (wt) or more, 60% (wt) or more, 70% (wt) or more, 25-75% (wt), or 40-60% (wt) of a total weight of the sensory modifier. The sensory modifier can comprise a monocaffeoylquinic component selected from the group consisting of chlorogenic acid, neochlorogenic acid, cryptochlorogenic acid, and salts thereof. The sensory modifier can comprise a monocaffeoylquinic component and a dicaffeoylquinic component that together comprise more than 50% (wt), preferably more than 60% (wt), more than 70% (wt), more than 80% (wt), more than 90% (wt), or more than 95% (wt) of the sensory modifier. The sensory modifier can comprise less than 0.3% (wt) of malonate, malonic acid, oxalate, oxalic acid, lactate, lactic acid, succinate, succinic acid, malate, or malic acid; or less than 0.05% (wt) of pyruvate, pyruvic acid, fumarate, fumaric acid, tartrate, tartaric acid, sorbate, sorbic acid, acetate, or acetic acid; or less than 0.05% (wt) of chlorophyll; or less than 0.1% (wt) of furans, furan-containing chemicals, theobromine, theophylline, or trigonelline as a weight percentage on a dry weight basis of the sensory modifier. The sensory modifier can comprise 0% (wt) of malonate, malonic acid, oxalate, oxalic acid, lactate, lactic acid, succinate, succinic acid, malate, or malic acid; or 0% (wt) of chlorophyll.

The composition can additionally comprise a sweetener, preferably a high-intensity sweetener, e.g., a steviol glycoside. The composition can comprise at least 2% (wt), at least 3% (wt), at least 4% (wt), at least 5% (wt), at least 6% (wt), or at least 7% (wt) steviol glycoside. The steviol glycoside can comprise at least one of rebaudioside A, rebaudioside B, rebaudioside D, and rebaudioside M. The steviol glycoside can comprise at least 80% (wt) of rebaudioside M based on a total weight of steviol glycoside compounds in the effervescent composition.

The composition can additionally comprise a dry powdered creamer, a vitamin, a mineral, an antacid, an electrolyte, a pain reliever, or combinations thereof. The composition can comprise at least 1% (wt), at least 5% (wt), at least 10% (wt), at least 15% (wt), at least 20% (wt), at least 25% (wt), or at least 30% (wt) of a dry powdered creamer, vitamin, mineral, antacid, electrolyte, pain reliever, or combinations thereof.

For example, the disclosure provides a composition comprising a dry powdered creamer, an effervescent agent comprising an acid and a base, and a sensory modifier. The composition can comprise at least 10% (wt), at least 15% (wt), at least 20% (wt), at least 25% (wt), or at least 30% (wt) of the creamer. The composition can comprise between 10%-60% (wt), 15%-55% (wt), 20%-50% (wt), or 25% to 45% (wt) of the creamer. The creamer can comprise a non-dairy creamer. The creamer can comprise a lactose-free non-dairy creamer. The creamer can comprise a non-diary creamer comprising a powdered coconut milk, a powdered almond milk, a powdered soy milk, a powdered rice milk, or combinations thereof. The creamer can comprise a dry animal milk powder.

The disclosure also provides a beverage prepared by adding the composition comprising an effervescent agent and a sensory modifier to water or an aqueous solution. The beverage can comprise 50 ppm to 1000 ppm of the sensory modifier. The beverage can comprise 75 ppm to 600 ppm of the sensory modifier. The beverage can comprise 100 ppm to 500 ppm of the sensory modifier. The beverage can comprise a sweetener. The beverage can comprise a steviol glycoside. The beverage can be a coffee beverage. Upon addition of the composition to water or an aqueous solution, a foam can be formed. The foam may be formed across the top of the beverage. The foam may remain on top of the beverage for at least 30 seconds, at least 1 minutes, or at least 2 minutes following addition of the composition to the water or aqueous solution.

The disclosure further provides a beverage product, e.g., a dry powdered beverage comprising a composition comprising an effervescent agent comprising an acid and a base and a sensory modifier.

The disclosure also provides a method for preparing a beverage with reduced saltiness. The method comprises adding an effervescent composition comprising an effervescent agent and a sensory modifier to water or an aqueous solution to form the beverage composition, wherein the effervescent composition comprises an acid and a base and the sensory modifier comprises (i) a dicaffeoylquinic acid or salt thereof, and (ii) one or more compounds selected from the group consisting of monocaffeoylquinic acids, monoferuloylquinic acids, diferuloylquinic acids, monocoumaroylquinic acids, dicoumaroylquinic acids, and salts thereof, wherein saltiness of the beverage composition is reduced relative to saltiness of a beverage prepared with an equivalent effervescent composition lacking the sensory modifier. A saltiness intensity value of the beverage is reduced by at least 1 unit, at least 2 units, at least 3 units, at least 4 units, or at least 5 units relative to a saltiness intensity value of a beverage prepared with an equivalent effervescent composition lacking the sensory modifier, wherein saltiness intensity value is measured by the Standardized Saltiness Intensity Test.

### BRIEF DESCRIPTION OF THE FIGURES

The drawings illustrate generally, by way of example, but not by way of limitation, various aspects discussed herein.

FIG. 1 shows pictures of an effervescent coffee creamer tablet as described in Example 4.

FIG. 2 shows a picture of an encapsulated coffee creamer tablet as described in Example 5.

FIG. 3 shows a coffee beverage prepared with an encapsulated coffee creamer tablet according to Example 5.

FIG. 4 shows a coffee beverage about 1 minutes after preparation with an encapsulated coffee creamer tablet according to Example 5.

FIG. 5 shows a comparison of the 1.5 g tablets and 6 g cubes described in Example 4.

### DETAILED DESCRIPTION

Reference will now be made in detail to certain aspects of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

In this document, the terms “a,” “an,” or “the” are used to include one or more than one unless the context clearly dictates otherwise. The term “or” is used to refer to a nonexclusive “or” unless otherwise indicated. All publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

Values expressed in a range format should be interpreted in a flexible manner to include not only the numerical values explicitly recited as the limits of the range, but also to include all the individual numerical values or sub-ranges encompassed within that range as if each numerical value and sub-range were explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

Unless expressly stated, ppm (parts per million), percentage, and ratios are on a by weight basis. Percentage on a by weight basis is also referred to as wt % or % (wt) below.

This disclosure relates to various effervescent compositions which have improved sensory attributes, such as reduced saltiness and/or reduced bitterness. The disclosure further relates to beverages made with the effervescent compositions, the beverages having improved sensory attributes, such as reduced saltiness and/or reduce bitterness. The disclosure also relates, generally, to a sensory modifier and uses thereof. In various aspects, the sensory modifier contains one or more caffeoyl-substituted quinic acid, and salts thereof. The disclosure further relates to methods of reducing undesirable attributes associated with salt components and providing an improved composition relative to salt compositions which lack the sensory modifier described herein.

### Effervescent Compositions

The present disclosure provides compositions containing an effervescent agent and various improvements which serve to modify the sensory perception thereof in use. In general, the effervescent agent of the effervescent compositions includes an acid and a base. The effervescent agent is activated when the dry effervescent agent is contacted with water or an aqueous solution. For example, when the dry effervescent agent is dissolved or dissociated in a glass of water, juice, or other beverage (e.g., a coffee beverage). When dissolved or dissociated into an aqueous solution or water, the acid and base components of the effervescent agent react to release a gas into the solution, preferably as discrete bubbles, e.g., bubbles of carbon dioxide, so the solution will effervesce.

As used herein, the terms “effervescent” and “effervesce” are used interchangeably and refer to the escape or release of gas from an aqueous solution and any foaming or fizzing resulting from said release of gas. In general, the effervescence will produce visible bubbles of the escaping gas that may increase or change with agitation.

As used herein, the term “effervescent agent” refers to a composition that, when contacted with water or an aqueous solution will cause the resulting solution to effervesce. In general, the effervescent agent will an acid and a base, which, when contacted with water or an aqueous solution will release bubbles of carbon dioxide.

As used herein, the term “solid effervescent composition” refers to dry, solid composition comprising an effervescent agent, which, when said solid composition is contacted with water or an aqueous solution will cause the resulting solution to effervesce. The solid effervescent composition may be in the form of a powder, a tablet, a cube, and the like.

The effervescent compositions described herein can comprise at least 20% (wt), at least 30% (wt), at least 40% (wt), at least 45% (wt), or at least 50% (wt) of the effervescent agent. The effervescent composition can comprise between 20%-70% (wt), between 30%-65% (wt), or between 40%-60% (wt) of the effervescent agent.

The effervescent agent includes an acid and a base. The acid and the base can be present in the effervescent agent in any suitable weight or molar ratio, e.g., between 0.25:1 to 3:1. The weight ratio of the acid and base in the effervescent agent will depend on the chemical properties of the particular acid and base chosen. A skilled artisan will recognize how to formulate suitable combinations of acid and base to form the effervescent agent, e.g., in a molar ratio of acid to base such that a balanced reaction produces water and carbon dioxide from which a weight ratio can be calculated based on molecular weight of said acid and base.

Acids suitable for use in the effervescent agent can include any acid safe for human consumption, including acids recognized by the United Stated Food and Drug Administration as Generally Recognized As Safe (GRAS). For example, acids suitable for use in the effervescent agent may include, but are not limited to, citric acid, aspartic acid, malic acid, adipic acid, tartaric acid, fumaric acid, succinic acid, sodium acid pyrophosphate, lactic acid, hexamic acid, amino acid hydrochlorides, acid salts thereof, acid anhydrides thereof, and combinations thereof. The acid of the effervescent agent may be selected from the group consisting of citric acid, aspartic acid, malic acid, adipic acid, tartaric acid, fumaric acid, succinic acid, sodium acid pyrophosphate, lactic acid, hexamic acid, amino acid hydrochlorides, acid salts thereof, acid anhydrides thereof, and combinations thereof. In some aspects, the acid of the effervescent agent is at least one of citric acid, aspartic acid, malic acid, adipic acid, tartaric acid, fumaric acid, succinic acid, sodium acid pyrophosphate, lactic acid, hexamic acid, amino acid hydrochlorides, acid salts thereof, acid anhydrides thereof, and combinations thereof. In some aspects, the acid of the effervescent agent is selected from the group consisting of citric acid, aspartic acid, malic acid, adipic acid, tartaric acid, fumaric acid, and succinic acid. In some aspects, the acid of the effervescent agent comprises citric acid, aspartic acid, malic acid, adipic acid, tartaric acid, fumaric acid, or succinic acid. In some aspects, the acid is citric acid. The effervescent composition can include at least 2% (wt), at least 5% (wt), at least 10% (wt), at least 15% (wt), at least 20% (wt), at least 25% (wt), at least 30% (wt), at least 40% (wt), or at least 45% (wt) of the acid. The effervescent composition can include 2%-60% (wt), 5%-50% (wt), 10%-45% (wt), or 15%-40% (wt) of the acid.

Bases suitable for use in the effervescent agent can include any base safe for human consumption, including acids recognized by the United Stated Food and Drug Administration as Generally Recognized As Safe (GRAS). For example, bases suitable for use in the effervescent agent can include, but are not limited to, metal carbonate bases, e.g., potassium bicarbonate, sodium bicarbonate, sodium carbonate, sodium sesquicarbonate, potassium carbonate, calcium carbonate, magnesium carbonate, zinc carbonate, and combinations thereof. The base of the effervescent agent may be selected from the group consisting of potassium bicarbonate, sodium bicarbonate, sodium carbonate, sodium sesquicarbonate, potassium carbonate, calcium carbonate, magnesium carbonate, zinc carbonate, and combinations thereof. The base of the effervescent agent may be at least one of potassium bicarbonate, sodium bicarbonate, sodium carbonate, sodium sesquicarbonate, potassium carbonate, calcium carbonate, magnesium carbonate, zinc carbonate, and combinations thereof. In some aspects, the base is selected from the group consisting of potassium bicarbonate, sodium bicarbonate, sodium carbonate, sodium sesquicarbonate, potassium carbonate, and combinations thereof. In same aspects, the base of the effervescent agent comprises potassium bicarbonate, sodium bicarbonate, sodium carbonate, sodium sesquicarbonate, potassium carbonate, and combinations thereof. In some aspects, the base is potassium bicarbonate or sodium bicarbonate. The effervescent composition can include at least 2% (wt), at least 5% (wt), at least 10% (wt), at least 15% (wt), at least 20% (wt), at least 25% (wt), at least 30% (wt), at least 40% (wt), or at least 45% (wt) of the base. The effervescent composition can include 2%-60% (wt), 5%-50% (wt), 10%-45% (wt), or 15%-40% (wt) of the base.

### Sensory Modifier

A sensory modifier is a compound or composition that in certain amounts changes the sensory characteristics or sensory attributes of a consumable, e.g., a beverage, a food product, etc. Non-limiting examples of sensory characteristics that a sensory modifier can change include bitterness, sourness, numbness, astringency, metallicness, cloyingness, dryness, sweetness, temporal aspects of sweetness, as well as flavor notes, such as licorice, vanilla, prune, cotton candy, and molasses flavor notes. The sensory modifier may enhance a sensory characteristic, such as enhancing sweetness; may suppress a sensory characteristic, such as reducing bitterness or reducing saltiness; or may change the temporal aspects of a sensory characteristic, e.g., by reducing sweetness lingering, or a combination thereof. In some aspects, the amount employed in a salt composition having a sodium salt, a potassium salt, a magnesium salt, or combinations thereof and one or more sensory modifiers alters at least one sensory characteristic, e.g., the combination may have reduced bitterness or reduced saltiness compared to the salt composition without the sensory modifiers, which resulting sensory characteristic in the composition is better than expected.

The present disclosure provides a sensory modifier comprising one or more caffeoyl-substituted quinic acids, and salts thereof. In various aspects, the caffeoyl-substituted quinic acids comprise an ester derived from the carboxylic acid of caffeic acid and an alcohol of quinic acid. A “caffeoyl-substituted quinic acid” or “caffeoylquinic acid” as the terms are used herein, include monocaffeoylquinic acids and dicaffeoylquinic acids and salts thereof. Monocaffeoylquinic acids comprise an ester derived from a single caffeic acid and a quinic acid (e.g., chlorogenic acid (5-O-caffeoylquinic acid), neochlorogenic acid (3-O-caffeoylquinic acid), and cryptochlorogenic acid (4-O-caffeoylquinic acid)). Dicaffeoylquinic acids comprise an ester derived from two caffeic acids and a quinic acid (e.g., 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, and 4,5-dicaffeoylquinic acid)). Thus, the sensory modifier includes both acid forms and salt forms of caffeoyl-substituted quinic acids. Free acid forms of various caffeoyl-substituted quinic acids are shown in Table 1.

TABLE 1
Structures of various caffeoyl-substituted quinic acids.

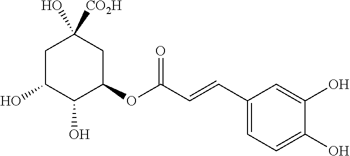 [SMILES: O=C(/C=C/c1ccc(O)c(O)c1)O[C@@H]1C[C@](O)(C(=O)O)C[C@@H](O)[C@H]1O]

Chlorogenic acid (5-O-caffeoylquinic acid)

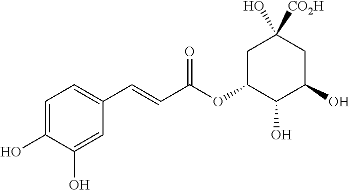 [SMILES: O=C(/C=C/c1ccc(O)c(O)c1)O[C@@H]1C[C@@](O)(C(=O)O)C[C@@H](O)[C@@H]1O]

Neochlorogenic acid (3-O-caffeoylquinic acid)

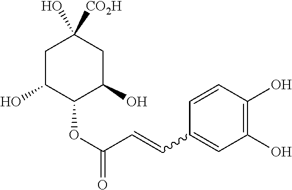 [SMILES: O=C(C=Cc1ccc(O)c(O)c1)O[C@H]1[C@H](O)C[C@](O)(C(=O)O)C[C@H]1O]

Cryptochlorogenic acid (4-O-
caffeoylquinic acid)

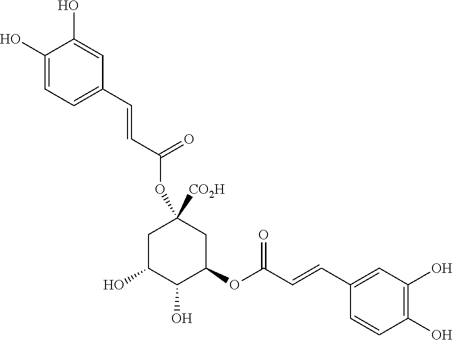 [SMILES: O=C(/C=C/c1ccc(O)c(O)c1)O[C@@H]1C[C@](OC(=O)/C=C/c2ccc(O)c(O)c2)(C(=O)O)C[C@@H](O)[C@H]1O]

1,5-Dicaffeoylquinic acid

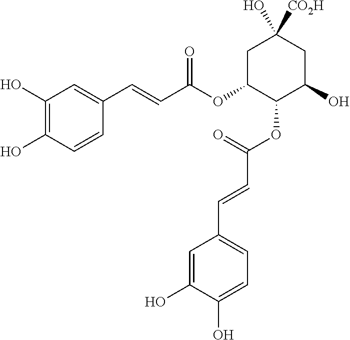 [SMILES: O=C(/C=C/c1ccc(O)c(O)c1)O[C@H]1[C@H](O)C[C@](O)(C(=O)O)C[C@H]1OC(=O)/C=C/c1ccc(O)c(O)c1]

3,4-Dicaffeoylquinic acid

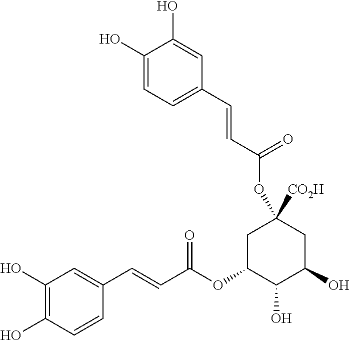 [SMILES: O=C(/C=C/c1ccc(O)c(O)c1)O[C@@H]1C[C@@](OC(=O)/C=C/c2ccc(O)c(O)c2)(C(=O)O)C[C@@H](O)[C@@H]1O]

1,3-Dicaffeoylquinic acid

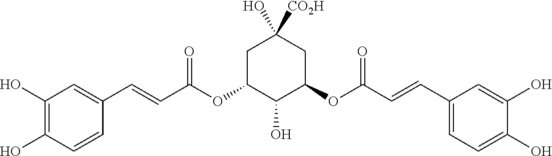 [SMILES: O=C(/C=C/c1ccc(O)c(O)c1)O[C@@H]1C[C@](O)(C(=O)O)C[C@@H](OC(=O)/C=C/c2ccc(O)c(O)c2)[C@H]1O]

3,5-Dicaffeoylquinic acid

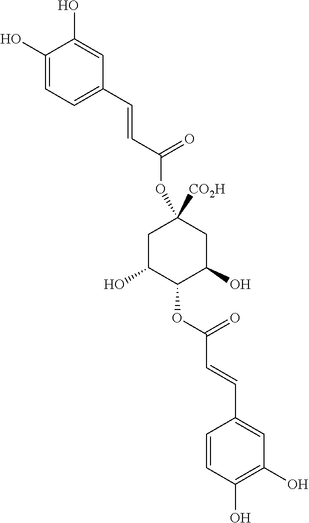 [SMILES: O=C(/C=C/c1ccc(O)c(O)c1)O[C@H]1[C@H](O)C[C@](OC(=O)/C=C/c2ccc(O)c(O)c2)(C(=O)O)C[C@H]1O]

1,4-Dicaffeoylquinic acid

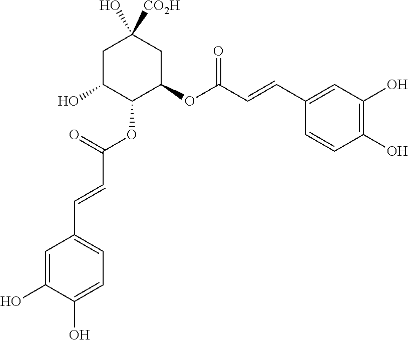 [SMILES: O=C(/C=C/c1ccc(O)c(O)c1)O[C@@H]1[C@H](O)C[C@@](O)(C(=O)O)C[C@H]1OC(=O)/C=C/c1ccc(O)c(O)c1]

4,5-Dicaffeoylquinic acid

In various aspects, the sensory modifier further comprises one or more of quinic acid, caffeic acid, ferulic acid, sinapic acid, p-coumaric acid, an ester of quinic acid, an ester of caffeic acid, an ester of ferulic acid, an ester of sinapic acid, an ester of p-coumaric acid, an ester of caffeic acid and quinic acid, an ester of caffeic acid and quinic acid comprising a single caffeic acid moiety, an ester of caffeic acid and quinic acid comprising more than one caffeic acid moiety, an ester of ferulic acid and quinic acid, an ester of ferulic acid and quinic acid comprising a single ferulic acid moiety, an ester of ferulic acid and quinic acid comprising more than one ferulic acid moiety, an ester of sinapic acid and quinic acid, an ester of sinapic acid and quinic acid comprising a single sinapic acid moiety, an ester of sinapic acid and quinic acid comprising more than one sinapic acid moiety, an ester of p-coumaric acid and quinic acid, an ester of p-coumaric acid and quinic acid comprising a single p-coumaric acid moiety, an ester of p-coumaric acid and quinic acid comprising more than one p-coumaric acid moiety, a di-ester of quinic acid containing one caffeic acid moiety and one ferulic acid moiety, a caffeic ester of 3-(3,4-dihydroxyphenyl)lactic acid, a caffeic acid ester of tartaric acid, a caffeic acid ester of tartaric acid containing more than one caffeic acid moieties, and/or isomers thereof, and the corresponding salts.

In some aspects, the sensory modifier comprises one or more of chlorogenic acid (5-O-caffeoylquinic acid), neochlorogenic acid (3-O-caffeoylquinic acid), cryptochlorogenic acid (4-O-caffeoylquinic acid), 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, 4,5-dicaffeoylquinic acid, 3-O-feruloylquinic acid, 4-O-feruloylquinic acid, 5-O-feruloylquinic acid, 1,3-diferuloylquinic acid, 1,4-diferuloylquinic acid, 1,5-diferuloylquinic acid, 3,4-diferuloylquinic acid, 3,5-diferuloylquinic acid, 4,5-diferuloylquinic acid, rosmarinic acid, caftaric acid (monocaffeoyltartaric acid), cichoric acid (dicaffeoyltartaric acid) and salts, and/or isomers thereof, and the corresponding salts.

In some aspects, the sensory modifier consists essentially of one or more compounds selected from the list consisting of chlorogenic acid (5-O-caffeoylquinic acid), neochlorogenic acid (3-O-caffeoylquinic acid), cryptochlorogenic acid (4-O-caffeoylquinic acid), 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, and 4,5-dicaffeoylquinic acid, and any combination thereof, isomers thereof, and the corresponding salts. In various aspects, one or more alcohol of the caffeoyl moiety is replaced with a hydrogen or substituted with an C1-C10 alkyl (e.g., methyl, ethyl, propyl, etc), C1-C10 alkenyl, C6-C10 aryl, C2-C10 acyl, acrylate, caffeoyl, o-coumaroyl, p-coumarovl, m-coumaroyl, cinnamoyl, 4-hydroxycinnamoyl, feruloyl, iso-feruloyl, sinapoyl, galloyl, sulfate, phosphate, or phosphonate. Thus, modified and substituted caffeic acid moieties result in a cinnamic acid, o-coumaroyl, p-coumaric acid, m-coumaric acid, ferulic acid, and the acyl and ester forms thereof. In various aspects, one or more alcohol of the quinic acid moiety is substituted with an C1-C10 alkyl (e.g., methyl, ethyl, propyl, etc.), C1-C10 alkenyl, C6-C10 aryl, C2-C10 acyl, acrylate, caffeoyl, o-coumaroyl, p-coumaroyl, m-coumaroyl, cinnamoyl, 4-hydroxycinnamoyl, feruloyl, iso-feruloyl, sinapoyl, galloyl, sulfate, phosphate, or phosphonate.

The sensory modifier can include one or more of a caffeic ester of 3-(3,4-dihydroxyphenyl)lactic acid, a caffeic acid ester of tartaric acid, a ferulic ester of quinic acid or any other optionally-substituted cinnamoyl ester of quinic acid other than a caffeoylquinic acid. Examples of a ferulic ester of quinic acid includes 3-O-feruloylquinic acid, 4-O-feruloylquinic acid, 5-O-feruloylquinic acid, 1,3-diferuloylquinic acid, 1,4-diferuloylquinic acid, 1,5-diferuloylquinic acid, 3,4-diferuloylquinic acid, 3,5-diferuloylquinic acid, 4,5-diferuloylquinic acid, and combinations thereof. An example of a caffeic ester of 3-(3,4-dihydroxyphenyl)lactic acid is rosmarinic acid. Examples of a caffeic acid ester of tartaric acid includes cichoric acid (dicaffeoyltartaric acid) and caftaric acid (monocaffeoyltartaric acid) and combinations thereof.

In an alternative aspect, the sensory modifier is a mixture consisting of one or more of a caffeic ester of 3-(3,4-dihydroxyphenyl)lactic acid, a caffeic acid ester of tartaric acid, a ferulic ester of quinic acid or any other optionally-substituted cinnamoyl ester of quinic acid other than a caffeoylquinic acid. Such sensory modifier also includes salts thereof so as to have a salt fraction and an acid fraction. It is thus further envisaged that each of the various aspects described herein related to caffeoylquinic acid and other sensory modifiers can be equally applicable to this alternative.

Caffeic acid has the structure:

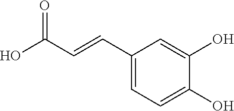 [SMILES: O=C(O)/C=C/c1ccc(O)c(O)c1]

Quinic acid has the structure:

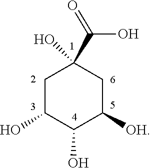 [SMILES: O=C(O)[C@]1(O)C[C@@H](O)[C@@H](O)[C@H](O)C1]

The structure provided above is D-(—)-quinic acid and the numbers shown correspond to current IUPAC numbering.

In various aspects, the sensory modifier can be enriched for one or more of caffeic acid, monocaffeoylquinic acids, and dicaffeoylquinic acids. The term “enriched” refers to an increase in an amount of one of caffeic acid, monocaffeoylquinic acids, and dicaffeoylquinic acids relative to one or more other compounds that are present in the sensory modifier. A sensory modifier that is enriched for one or more of caffeic acid, monocaffeoylquinic acids, and dicaffeoylquinic acids can modify the sensory attributes of the salt composition.

The sensory modifier enriched for one or more dicaffeoylquinic acids can modify the sensory attributes of a salt composition. A sensory modifier that is enriched for dicaffeoylquinic acids can comprise 10% or more, 15% or more, 20% or more, 25% or more, 30% or more, 35% or more, 40% or more, 45% or more, or 50% or more, 60% or more, 70% or more, or 80% or more, or 90% or more dicaffeoylquinic acids as a percentage of the total weight of the sensory modifier.

In various aspects, at least or about 10 wt %, 15 wt %, 20 wt %, 25 wt %, 30 wt %, 35 wt %, 40 wt %, 45 wt %, or at least or about 50 wt % of the total sensory modifier can be monocaffeoylquinic acids and salts thereof. In various aspects, at least or about 10 wt %, 15 wt %, 20 wt %, 25 wt %, 30 wt %, 35 wt %, 40 wt %, 45 wt %, or at least or about 50 wt % of the total sensory modifier can be chlorogenic acid (5-O-caffeoylquinic acid) and salts thereof. In various aspects, at least or about 10 wt %, 15 wt %, 20 wt %, 25 wt %, 30 wt %, 35 wt %, 40 wt %, 45 wt %, or at least or about 50 wt % of the total sensory modifier can be neochlorogenic acid (3-O-caffeoylquinic acid) and salts thereof. In various aspects, at least or about 10 wt %, 15 wt %, 20 wt %, 25 wt %, 30 wt %, 35 wt %, 40 wt %, 45 wt %, or at least or about 50 wt % of the total sensory modifier can be cryptochlorogenic acid (4-O-caffeoylquinic acid) and salts thereof.

In various further aspects, at least or about 10 wt %, 15 wt %, 20 wt %, 25 wt %, 30 wt %, 35 wt %, 40 wt %, 45 wt %, or at least or about 50 wt % of the total sensory modifier can be 1,3-dicaffeoylquinic acid and salts thereof. In various aspects, at least or about 10 wt %, 15 wt %, 20 wt %, 25 wt %, 30 wt %, 35 wt %, 40 wt %, 45 wt %, or at least or about 50 wt % of the total sensory modifier can be 1,4-dicaffeoylquinic acid and salts thereof. In various aspects, at least or about 10 wt %, 15 wt %, 20 wt %, 25 wt %, 30 wt %, 35 wt %, 40 wt %, 45 wt %, or at least or about 50 wt % of the total sensory modifier can be 1,5-dicaffeoylquinic acid and salts thereof. In various aspects, at least or about 10 wt %, 15 wt %, 20 wt %, 25 wt %, 30 wt %, 35 wt %, 40 wt %, 45 wt %, or at least or about 50 wt % of the total sensory modifier can be 3,4-dicaffeoylquinic acid and salts thereof. In various aspects, at least or about 10 wt %, 15 wt %, 20 wt %, 25 wt %, 30 wt %, 35 wt %, 40 wt %, 45 wt %, or at least or about 50 wt % of the total sensory modifier can be 3,5-dicaffeoylquinic acid and salts thereof. In various aspects, at least or about 10 wt %, 15 wt %, 20 wt %, 25 wt %, 30 wt %, 35 wt %, 40 wt %, 45 wt %, or at least or about 50 wt % of the total sensory modifier can be 4,5-dicaffeoylquinic acid and salts thereof.

The sensory modifier can, for example, have a weight ratio of total monocaffeoylquinic acids and salts to total dicaffeoylquinic acids and salts of 20:1 to 1:20, e.g., from 3:1 to 1:20. In various aspects, the sensory modifier has a weight ratio from 15:1 to 1:15, from 10: 1 to 1:10, from 5:1 to 1:5, from 3:1 to 1:3, from 2:1 to 1:2, from 1.5:1 to 1:1.5, from 5:1 to 1:1, from 3:1 to 1:1, from 2:1 to 1:1, from 1.5:1 to 1: 1.1, from 1: 1 to 1:20, from 1:1 to 1:15, from 1:1 to 1:10, from 1:5 to 1:20, from 1:5 to 1:15, from 1:5 to 1:10, from 1:2 to 1:20, from 1:2 to 1:15, from 1:2 to 1:10, from 1:2 to 1:5, from 1:1 to 1:3, from 1:1 to 1:2, or from 1: 1 to 1:1.5 monocaffeoylquinic acid and salts thereof: dicaffeoylquinic acids and salts thereof. In some aspects, the sensory modifier has a greater amount, by weight, of dicaffeoylquinic acids and salts of dicaffeoylquinic acids compared to the amount of monocaffeoylquinic acids and salts of monocaffeoylquinic acids. In various aspects, the sensory modifier has a ratio of about 1:1 of monocaffeoylquinic acid:dicaffeoylquinic acids, including salts thereof.

The sensory modifier provided herein may contain a portion that is in salt form (corresponding to a “salt fraction”) and a portion that is in acid form (corresponding to an “acid fraction”). In various aspects, the salt fraction accounts for at least 50 wt % of the total sensory modifier. In various aspects, the sensory modifier comprises a salt fraction and an acid fraction, wherein the salt fraction comprises one or more of a salt of a monocaffeoylquinic acid and a salt of a dicaffeoylquinic acid, wherein the acid fraction comprises one or more of a monocaffeoylquinic acid and a dicaffeoylquinic acid, and wherein the salt fraction comprises at least 50 wt % of the total sensory modifier.

For example, the salt fraction comprises at least or about 50 wt %, 55 wt %, 60 wt %, 65 wt %, 70 wt %, 75 wt %, 80 wt %, 85 wt %, or at least or about 90 wt % of the total sensory modifier. In further aspects, the salt fraction comprises less than or about 60 wt %, 65 wt %, 70 wt %, 75 wt %, 80 wt %, 85 wt %, or less than or about 90 wt % of the total sensory modifier. In yet further aspects, the salt fraction comprises 50 wt % to 90 wt %, 50 wt % to 80 wt %, 50 wt % to 75 wt %, 60 wt % to 90 wt %, 60 wt % to 80 wt %, 65 wt % to 80 wt %, or 65 wt % to 75 wt % of the total sensory modifier. Unless otherwise specified the wt % of the salt fraction should be calculated inclusive of the balancing cation species.

In further examples, the acid fraction comprises at least or about 5 wt %, 10 wt %, 15 wt %, 20 wt %, 25 wt %, 30 wt %, 35 wt %, 40 wt %, or at least or about 45 wt % of the total sensory modifier. In further aspects, the acid fraction comprises less than or about 10 wt %, 15 wt %, 20 wt %, 25 wt %, 30 wt %, 35 wt %, 40 wt %, or less than about 50 wt % of the total sensory modifier. In yet further aspects, the acid fraction comprises 5 wt % to 50 wt %, 10 wt % to 50 wt %, 15 wt % to 50 wt %, 20 wt % to 50 wt %, 5 wt % to 40 wt %, 10 wt % to 40 wt %, 15 wt % to 40 wt %, 20 wt % to 40 wt %, 5 wt % to 35 wt %, 10 wt % to 35 wt %, 15 wt % to 35 wt %, 20 wt % to 35 wt %, 5 wt % to 30 wt %, 10 wt % to 30 wt %, 15 wt % to 30 wt %, 20 wt % to 30 wt %, 5 wt % to 20 wt %, 10 wt % to 20 wt %, 15 wt % to 20 wt %, 5 wt % to 15 wt %, 10 wt % to 15 wt %, or 5 wt % to 10 wt % of the total sensory modifier.

In various aspects, e.g., in an aqueous solution, the salt form of the total sensory modifier exists in equilibrium with the acid form. For example, a particular salt form molecule can become protonated and thus convert into the acid form and an acid form molecule can be come deprotonated to result in a salt form. After approaching or achieving equilibrium, such interplay will not substantially alter the overall wt % of a given form or fraction of the total sensory modifier. For example, a composition having a salt fraction of 50 wt % or more of the total sensory modifier can maintain the same proportions of salt and acid fractions even though the various compounds might exchange from one fraction to another.

There are also cases where the equilibrium between salt and acids forms can shift in response to the addition of components to the composition. For example, addition of buffer solution, salts, acid, or base can shift the equilibrium to favor the salt or acid fraction, and thus alter the wt % of the composition.

In various other aspects, e.g., in a solid composition, the salt form and acid forms can be in a solid state, in which the proportion between salt and acid forms is frozen. It should be understood that, in various aspects, the ratio of the salt fraction to acid fraction in a solid composition, such as a granulated salt composition, can differ from that of a resulting solution to which the solid composition is added. For example, in some aspects, a solid-state salt composition will, upon dissolving or disintegrating, result in a solution having a sensory modifier of which at least 50 wt % is in salt form.

### Effective Amount of Sensory Modifier

The compositions of the present disclosure comprise a sensory modifier in an amount effective to reduce saltiness intensity of the effervescent composition when added to water or an aqueous solution.

A sensory panel can be used to determine the magnitude of, for example, reduction in bitterness or shifts in its temporal profile, thereby quantifying the amount of sensory modifier effective to reduce said bitterness. Sensory panels are a scientific and reproducible method that is essential to the food and beverage industry. A sensory panel involves a group of two or more individual panelists. Panelists are instructed according to industry-recognized practices to avoid the influence of personal subjectivity and strengthen reproducibility. For example, panelists may objectively evaluate sensory attributes of a tested product but may not provide subjective attributes such as personal preference. In various aspects, the sensory panel can be conducted with two, three, four, five, six, or more panelists, in which the panelists identify and agree on a lexicon of sensory attributes for a given set of samples. After evaluating a specific sample, the panelists can assign a numerical intensity score for each attribute using an intensity scale. For example, intensity scales can range from 0 to 6 (i.e., 0=not detected, 1=trace, 2=slight, 3=moderate, 4=definite, 5=strong, 6=extreme), 0 to 9 (i.e., 0=not detected, 1=trace, 2=faint, 3=slight, 4=mild, 5=moderate, 6=definite, 7=strong, 8=very strong, 9=extreme), or 0 to 15, where 0 corresponds to the absence of the attribute, while 6, 9, or 15, respectively, corresponds to the upper bound extreme occurrence of the attribute. The panel may use a roundtable consensus approach, or the panelists may score and evaluate the sensory attribute(s) individually. Either format can further involve a panel leader who directs the discussion regarding terminology and directs the panel to evaluate particular products and attributes. In other aspects, a trained sensory panel can be utilized to assess specific attributes using descriptive analysis or time intensity methodologies.

As used herein, “panelist” refers to a highly trained expert taster, such as those commonly used for sensory methodologies such as descriptive analysis, and/or an experienced taster familiar with the sensory attribute(s) being tested. In some aspects, the panelist may be a trained panelist. A trained panelist has undergone training to understand the terms and sensory phenomenon associated with those sensory attributes relevant to the tested product and are aligned on the use of common descriptors for those sensory attributes of interest (i.e., a sensory lexicon). For example, a trained panelist testing a given composition will understand the terms and sensory attributes associated with said composition, e.g., saltiness, sourness, bitterness, astringency, mouthfeel, acidity, and the like. The trained panelist will have been trained against reference samples corresponding to the sensory attributes being tested and thus have calibrated to recognize and quantitatively assess such criteria. In some aspects, the panelist may be an experienced taster.

As used herein, “roundtable consensus approach” refers to the sensory panel assay methodology wherein panelists discus sensory attributes and intensities before mutually agreeing on an intensity score and attribute characterization for the particular sensory attribute(s) being assayed. A sensory panel using a roundtable consensus approach may include 2, 3, 4, 5, 6, or more panelists. Consensus intensity scales can range from 0 to 6 (i.e., 0=not detected, 1=trace, 2=slight, 3=moderate, 4=definite, 5=strong, 6=extreme) or 0 to 9 (i.e., 0=not detected, 1=trace, 2=faint, 3=slight, 4=mild, 5=moderate, 6=definite, 7=strong, 8=very strong, 9=extreme). For a given set of samples, the panelists will identify and agree on a lexicon of sensory attribute, including, if applicable, reference or standardized samples (also referred to as sensory anchors) for a particular sensory attribute. The reference sample(s) used for a given sensory attribute(s) will depend on the samples being assayed and the lexicon of sensory attributes determined by the panel. One of skill in the art will recognize the appropriate lexicon and reference or standard samples necessary for sensory assessment of a given sample(s).

In some aspects, the samples are scored and evaluated by panelists independently after panelists have agreed upon or been instructed in a lexicon of sensory attributes and intensity scores including. if applicable, assay specific calibration on reference samples (also referred to as sensory anchors) for a particular sensory attribute. Examples of common reference samples are described below. Panelists may evaluate samples in replicate and may be blinded to the samples they are testing. Samples being tested may be provided to the panelists randomly or in a sequential order. In some aspects, samples may be tested by panelists using a randomized balanced sequential order. Scores from individual panelists are then assessed using standard statistical analysis methods to determine an average sensory intensity score. One of skill in the art will recognize the appropriate lexicon and reference or standard samples necessary for sensory assessment of a given sample(s) as well as the appropriate statistical analysis methods.

As used herein, “randomized balanced sequential order” refers to the order in which samples are presented in which the order is randomized but across all panelists all possible orders of the samples will be presented to remove bias for the samples being tested in a particular order. For example, for a randomized balanced sequential order of two samples, there would be an equal likelihood that a given panelist receives sample 1 before sample 2 and sample 2 before sample 1. In an example with three samples (i.e., samples 1, 2, and 3), a randomized balanced sequential order would include an equal likelihood that panelists receiving samples in the following orders: (i) 1, 2, 3; (ii) 1, 3, 2; (iii) 2, 1, 3; (iv) 2, 3, 1; (v) 3, 2, 1; (vi) 3, 1, 2.

A sensory attribute(s) of a given composition may be evaluated in comparison to one or more reference or anchor samples. For example, sodium chloride solutions can be used by experienced panelists as saltiness anchors to assess the relative intensity of saltiness for a given composition; sucrose solutions can be used by experienced panelists as sweetness anchors to assess the relative intensity of sweetness for a given composition; citric acid solutions can be used by experienced panelists as sourness anchors to assess the relative intensity of sourness for a given composition; caffeine solutions can be used by experienced panelists as bitterness anchors to assess the relative intensity of bitterness for a given composition; and monosodium glutamate (MSG) solutions can be used by experienced panelists as umami anchors to assess the relative intensity of umami for a given composition. Experienced panelists can be presented with a solution to assess sensory attributes, e.g., 10-20 mL of a sample. Panelists will dispense approximately 3-4 mL of each solution into their own mouths, disperse the solution by moving their tongues, and record a value for the particular sensory attribute being tested. If multiple solutions are to be tested in a session, the panelists may cleanse their palates with water between samples. For example, a roundtable assessment of saltiness, sweetness, sourness, umami, and the like can assign a scale of 0 to 9 with, e.g., a score of 0 indicating no saltiness and a score of 9 indicating extreme saltiness (0=not detected, 1=trace, 2=faint, 3=slight, 4=mild, 5=moderate, 6=definite, 7=strong, 8=very strong, 9=extreme). Equivalent scales and methodologies can be used for sweet, bitter, sour, and umami sensory attributes.

As a further example, saltiness of the solutions can be tested by a panel of at least two individuals that are experienced in sensory testing. The panelists can use a standard range of 0.18%, 0.2%, 0.35%, 0.5%, 0.567%, 0.6%, 0.65%, and 0.7% sodium chloride solutions corresponding to a saltiness intensity value of 2, 2.5, 5, 8.5, 10, 11, 13, and 15, respectively. For each test solution, the experienced panelist dispenses approximately 3.5 mL of each solution into their own mouths, disperses the solution by moving their tongues, and records a saltiness intensity value between 0 and 15 for each solution based on comparison to the aforementioned standard sodium chloride solutions. Between tasting solutions, the panelists are able to cleanse their palates with water. The panelists also can taste the standard 0.18%, 0.2%, 0.35%, 0.5%, 0.567%, 0.6%, 0.65%, and 0.7% sodium chloride solutions ad libitum between tasting test solutions to ensure recorded saltiness intensity values are accurate against the scale of the standard sodium chloride solutions. This test measured in water at 22° C. (e.g., room temperature) is referred to herein as the “Standardized Saltiness Intensity Test.”

A control sample is typically used as a reference point or for comparison purposes. For example, a control sample can be used to qualify the effectiveness of a sensory modifier. The control sample can be a composition such as a solution comprising an effervescent agent component, but without the presence of the sensory modifier. Other than the sensory modifier, the control sample is otherwise the same, and it should contain the same effervescent agent component at the same concentration in the resultant solution. Other standard samples are commonly used in sensory panels, for example standard samples used to evaluate intensity of sensory attributes. In other aspects, the control sample may be a modified control sample which contains a different sensory modifier such as a competitor sensory modifier.

This disclosure is not limited to sensory testing by experienced or trained panelists. For example, it is possible to utilize untrained panelists. However, in the case of untrained panelists, a greater number of panelists is necessary to provide reproducible results, which will typically focus on subjective attributes such as preference or overall liking. Similarly, untrained panelists may be asked to evaluate relative changes in a given sensory attribute between two samples. For example, if a particular sample is more or less salty than a reference sample.

An exemplified sensory assay and test criteria for further sensory attributes are described in the Examples provided in this disclosure.

Additional description regarding roundtable sensory panels and sensory testing is set forth in PCT/US2018/054743, published Apr. 11, 2019 as WO 2019/071220; PCT/US2018/054691, published Apr. 11, 2019 as WO 2019/071182; U.S. application Ser. No. 16/373,206, published Jul. 25, 2019 as US Patent Application Publication No. 2019/0223481; U.S. application Ser. No. 16/374,422, published on Jul. 25, 2019 as US Patent Application Publication No. 2019/0223483; and PCT/US2020/026524, published Oct. 15, 2020 as WO 2020/210118 each of which is incorporated by reference herein in its entirety.

In some aspects, the amount of sensory modifier effective to decrease saltiness can be the amount effective to reduce saltiness intensity by at least 0.5, 1, 1.5, 2, or at least 2.5 units relative to bitterness intensity in an equivalent composition lacking the sensory modifier. The saltiness intensity score is determined by at least three panelists trained in tasting salty compositions using a roundtable methodology using a scale of 0 to 9, where a score of 0 indicates no saltiness and 9 indicates extreme saltiness intensity (i.e., 0=not detected, 1=trace, 2=faint, 3=slight, 4=mild, 5=moderate, 6=definite, 7=strong, 8=very strong, 9=extreme). In some aspects, the saltiness may be reduced by at least 2, at least 3, or at least 4 units. Similar evaluation processes may be used to score other sensory attributes of the composition described herein.

In some aspects, the amount of sensory modifier effective to decrease saltiness can be the amount effective to reduce saltiness intensity score by at least 0.5, 1, 1.5, 2, or at least 2.5 units relative to saltiness intensity in an equivalent composition lacking the sensory modifier. The saltiness intensity score may be determined as the average bitterness intensity score from at least seven panelists, trained in sensory evaluation, upon randomized balanced sequential order evaluation of samples using a scale of 0) to 15, where a score of 0) indicates no saltiness and 15 indicates extreme saltiness intensity. In some aspects, the saltiness may be reduced by at least 2, at least 3, at least 4 units, at least 5, at least 6, at least 7, or more units.

In some aspects, the amount of sensory modifier effective to decrease saltiness can be the amount effective to reduce a saltiness intensity value, measured by the Standardized Saltiness Intensity Test with at least four panelists experienced in sensory testing, by at least 1 unit. In other aspects, the amount effective to decrease saltiness comprises an amount effective to reduce a saltiness intensity value by at least 1 unit, 2 units, 3 units, 4 units, 5 units, 6 units, or more. In other aspects, the amount effective to decrease saltiness comprises an amount effective to reduce a saltiness intensity value to below 7, 6, 5, 4, 3, or 2 units. In some aspects, the amount effective to decrease saltiness comprises an amount effective to reduce a saltiness intensity value to zero.

The effervescent composition can have various amounts of sensory modifier. Sensory modifier can be present in the effervescent composition in any amount desired for the particular use. For example, the sensory modifier can be present in a dry effervescent composition at a total concentration from about 0.5% (wt) to about 20.0% (wt), from about 1.0% (wt) to about 15.0% (wt), or from about 1.5% (wt) to about 10.0% (wt). In some aspects, the sensory modifier is 1%-10% (wt), 2%-8% (wt), or 3%-6% (wt) of the effervescent composition. In some aspects, the sensory modifier can be present in a dry effervescent composition at a total concentration of at least 0.5%, 1.0%, 1.5%, 2.0%, 3.0%, 4.0%, 5.0%, 6.0%, 7.0%, 8.0%, 9.0%, or at least 10% by weight of the composition. In some aspects, the sensory modifier is at least 1% (wt), at least 2% (wt), at least 3% (wt), at least 4% (wt), at least 5% (wt), at least 6% (wt), at least 7% (wt), or at least 8% (wt) of the effervescent composition.

The dry effervescent composition can comprise an amount of sensory modifier such that, when the dry effervescent composition is added to an aqueous solution, the sensory modifier is present in the aqueous solution in an amount desired for a particular use. For example, sensory modifier can be present in the aqueous solution at a total concentration from about 1 ppm to about 1000 ppm, or from about 1 ppm to about 2000 ppm. In some aspects, sensory modifier can be present in the aqueous solution at a total concentration from about 100 ppm to about 2000 ppm, about 200 ppm to about 2000 ppm, 300 ppm to about 2000 ppm, 400 ppm to about 2000 ppm, 500 ppm to about 2000 ppm, 600 ppm to about 2000 ppm, 700 ppm to about 2000 ppm, 800 ppm to about 2000 ppm, 900 ppm to about 2000 ppm, or 1000 ppm to about 2000 ppm. In some aspects, sensory modifier can be present in the aqueous solution at a total concentration of or greater than about 10, 100, 200, 300, 400, 500, 600, 700, 800, 900, 1000, 110, 1200, 1300, 1400, 1500, 1600, 1700, 1800, 1900, or 2000 ppm. In various aspects, the sensory modifier can be present in the aqueous solution at a total concentration from about 100 ppm to about 1000 ppm, about 200 ppm to about 1000 ppm, 300 ppm to about 1000 ppm, 400 ppm to about 1000 ppm, 500 ppm to about 1000 ppm, 600 ppm to about 1000 ppm, 700 ppm to about 1000 ppm, 800 ppm to about 1000 ppm, or 900 ppm to about 1000 ppm. In some aspects, sensory modifier can be present in the aqueous solution at a total concentration from about 100 ppm to about 800 ppm, about 200 ppm to about 800 ppm, 300 ppm to about 800 ppm, 400 ppm to about 800 ppm, 500 ppm to about 800 ppm, 600 ppm to about 800 ppm, or 700 ppm to about 800 ppm. In some aspects, sensory modifier can be present in the aqueous solution at a total concentration from about 400 ppm to about 800 ppm.

The amount of an individual sensory modifier species in the various compositions described herewith can each independently vary. For example, monocaffeoylquinic acid, dicaffeoylquinic acid, or both, can each individually be present in the dry effervescent composition such that they are present in an aqueous solution prepared therefrom at a concentration from about 1 ppm to about 1000 ppm. In some aspects, monocaffeoylquinic acid, dicaffeoylquinic acid, or both, can each individually be present in the aqueous solution at a concentration from about 100 ppm to about 1000 ppm, about 200 ppm to about 1000 ppm, 300 ppm to about 1000 ppm, 400 ppm to about 1000 ppm, 500 ppm to about 1000 ppm, 600 ppm to about 1000 ppm. 700 ppm to about 1000 ppm, 800 ppm to about 1000 ppm, 900 ppm to about 1000 ppm. In some aspects, monocaffeoylquinic acid, dicaffeoylquinic acid, or both, can each individually be present at a concentration of or greater than about 10, 50, 100, 200, 300, 400, 500, 600, 700, 800, 900, or 1000 ppm in the aqueous solution prepared by adding the effervescent composition to an aqueous solution. In some aspects, monocaffeoylquinic acid, dicaffeoylquinic acid, or both, can each individually be present in the aqueous solution at a concentration from about 100 ppm to about 800 ppm, about 200 ppm to about 800 ppm, 300 ppm to about 800 ppm, 400 ppm to about 800 ppm, 500 ppm to about 800 ppm, 600 ppm to about 800 ppm, or 700 ppm to about 800 ppm. In some aspects, monocaffeoylquinic acid, dicaffeoylquinic acid, or both, can each individually be present in the aqueous solution at a concentration from about 400 ppm to about 800 ppm.

### Botanical Source of Sensory Modifier

In various aspects, the sensory modifier can be isolated from botanical sources. Various botanical sources comprise sensory modifiers and sensory modifiers can be isolated from these botanical sources. Some examples of botanical sources from which sensory modifiers can be isolated include Eucommia ulmoides, honeysuckle, Nicotiana benthamiana, artichoke, globe artichoke, cardoon, Stevia rebaudiana, monkfruit, coffee, coffee beans, green coffee beans, tea, white tea, yellow tea, green tea, oolong tea, black tea, red tea, post-fermented tea, bamboo, heather, sunflower, blueberries, cranberries, bilberries, grouseberries, whortleberry, lingonberry, cow berry, huckleberry, grapes, chicory, eastern purple coneflower, echinacea. Eastern pellitory-of-the-wall, Upright pellitory, Lichwort, Greater celandine, Tetterwort, Nipplewort, Swallowwort, Bloodroot, Common nettle, Stinging nettle, Potato, Potato leaves, Eggplant, Aubergine, Tomato, Cherry tomato, Bitter apple, Thorn apple, Sweet potato, apple, Peach, Nectarine, Cherry, Sour cherry, Wild cherry, Apricot, Almond, Plum, Prune, Holly, Yerba mate, Mate, Guayusa, Yaupon Holly, Kuding, Guarana, Cocoa, Cocoa bean, Cacao, Cacao bean, Kola nut, Kola tree, Cola nut, Cola tree, Ostrich fern, Oriental ostrich fern, Fiddlehead fern, Shuttlecock fern, Oriental ostrich fern, Asian royal fern, Royal fern, Bracken, Brake, Common bracken, Eagle fern, Eastern brakenfern, Clove, Cinnamon, Indian bay leaf, Nutmeg, Bay laurel, Bay leaf, Basil, Great basil, Saint-Joseph's-wort, Thyme, Sage, Garden sage, Common sage, Culinary sage, Rosemary, Oregano, Wild marjoram, Marjoram, Sweet marjoram, Knotted marjoram, Pot marjoram, Dill, Anise, Star anise, Fennel, Florence fennel, Tarragon, Estragon, Mugwort, Licorice, Liquorice, Soy, Soybean, Soyabean, Soya vean, Wheat, Common wheat, Rice, Canola, Broccoli, Cauliflower, Cabbage, Bok choy, Kale, Collard greens, Brussels sprouts, Kohlrabi, Winter's bark, Elderflower, Assa-Peixe, Greater burdock, Valerian, and Chamomile.

Some botanical sources may produce sensory modifiers that are enriched for one or more of caffeic acid, monocaffeoylquinic acids, and dicaffeoylquinic acids. For example, sensory modifiers isolated from yerba mate plant (Ilex paraguariensis) are enriched for monocaffeoylquinic and dicaffeoylquinic acids. In other aspects, sensory modifiers isolated from yerba mate plant that are enriched for dicaffeoylquinic acids can comprise 10% or more, 15% or more, 20% or more, 25% or more, 30% or more, 35% or more, 40% or more, 45% or more, or 50% or more, 60% or more, 70% or more, or 80% or more, or 90% or more of a combination of one or more of 1,3-dicaffeoylquinic acid, 1,4-dicaffeoylquinic acid, 1,5-dicaffeoylquinic acid, 3,4-dicaffeoylquinic, 3,5-dicaffeoylquinic acid, and 4,5-dicaffeoylquinic acid, and salts thereof. For example, sensory modifiers isolated from other botanical sources can be enriched for dicaffeoylquinic acids. In other aspects, sensory modifiers isolated from other botanical sources that are enriched for dicaffeoylquinic acids can comprise 10% or more, 15% or more, 20% or more, 25% or more, 30% or more, 35% or more, 40% or more, 45% or more, or 50% or more, 60% or more, 70% or more, or 80% or more, or 90% or more of a combination of one or more of 1,3-dicaffeoylquinic acid, 1,4-dicaffeoylquinic acid, 1,5-dicaffeoylquinic acid, 3,4-dicaffeoy lquinic acid, 3,5-dicaffeoylquinic acid, and 4,5-dicaffeoylquinic acid, and salts thereof.

Sensory modifier may be isolated in a variety of ways. Some suitable processes are disclosed in more detail in U.S. application Ser. No. 16/373,206, filed Apr. 4, 2019 and entitled “Steviol Glycoside Solubility Enhancers,” which was published on Jul. 25, 2019 as US Patent Application Publication No. 2019/0223481; International Application No. PCT/US2018/054691, filed Oct. 5, 2018 and entitled “Steviol Glycoside Solubility Enhancers;” U.S. Provisional Application No. 62/569,279, filed Oct. 6, 2017, and entitled “Steviol Glycoside Solubility Enhancers;” U.S. application Ser. No. 16/374,894, filed Apr. 4, 2019 and entitled “Methods for Making Yerba Mate Composition,” which was published on Aug. 1, 2019 as US Patent Application Publication No. 2019/0231834; International Application No. PCT/US2018/054688, filed Oct. 5, 2018 and entitled “Methods for Making Yerba Mate Composition;” U.S. Provisional Application Serial No. 62/676,722, filed May 25, 2018, and entitled “Methods for Making Yerba Mate Extract Composition;” and International Application No. PCT/US2020/026885 filed Apr. 6, 2020, entitled “Stevia Processing,” and published as WO 2020/210161 on Oct. 15, 2020, each of which is incorporated herein by reference. For example, sensory modifier may be isolated from a botanical source that comprises one or more of monocaffeoylquinic acid, dicaffeoylquinic acid, and salts thereof. For example, yerba mate biomass and stevia biomass can be used to prepare sensory modifier. In one exemplary process, sensory modifier is prepared from commercially obtained comminuted yerba mate biomass. Briefly, yerba mate biomass is suspended in 50% (v/v) ethanol/water, shaken for at least 1 hour, and the resulting mixture filtered to obtain an initial extract. The initial extract is diluted to 35% (v/v) ethanol with water and refiltered. Refiltered permeate is then applied to a column of AMBERLITE® FPA 53 resin that has been equilibrated in 35% (v/v) ethanol/water and the column permeate is discarded. The column is washed with 35% (v/v) ethanol/water and the column permeate is discarded. The column is then eluted with 10% (w/v) FCC grade sodium chloride in 50% (v/v) ethanol/water and the eluent retained. Nitrogen gas is blown at room temperature over a surface of the eluent to remove ethanol and reduce the eluent to ⅓ of its original volume. The reduced volume eluent is then filtered through a 0.2 μm polyethersulfone filter and then decolored by passing through a 3 kDa molecular weight cutoff membrane. The decolored permeate is retained and desalted by passing through a nanofiltration membrane. The desalted permeate is then freeze-dried to obtain the sensory modifier. This process is also suitable to obtain sensory modifier from stevia biomass and can be adapted to obtain sensory modifier from other botanical sources for example those described above.

In some aspects, the sensory modifier can be a blend of sensory modifier isolated from more than one botanical source.

Some compounds can adversely impact flavor or aroma of an aqueous solution or salt composition. Certain sensory modifiers, such as those prepared from plant extract do not include one or more of the compounds shown in Table 2, or any combination thereof, above the disclosed preferred content levels. All preferred content levels are stated as weight percent on a dry weight basis. Certain commercially desirable solid (dry) sensory modifiers do not include more than the preferred level of any of the compounds listed in Table 2. For those compounds listed that are acids, the compound may be present in acid form and/or in slat form.

TABLE 2

| Class of | Preferred Content | % wt of compounds in steviol glycoside |
|---|---|---|
| compounds | Level (% wt) | solubility enhancer solid (dry) compositions |
| Organic acids | <3%, preferably | malonate, malonic acid, oxalate, oxalic acid, |
| | <2%, <1%, or 0% | lactate, lactic acid, succinate, succinic acid, |
| | | malate, malic acid, citrate, citric acid |
| | <0.5%, preferably | tartrate, tartaric acid, pyruvate, pyruvic acid, |
| | <0.25% or 0% | fumarate, fumaric acid, ascorbic acid, sorbate, |
| | | sorbic acid, acetate, acetic acid |
| Inorganic acids | <1%, preferably | sulfate, sulfuric acid, phosphate, phosphoric |
| | <0.5% or 0% | acid, nitrate, nitric acid, nitrite, nitrous acid, |
| | | chloride, hydrochloric acid, ammonia, |
| | | ammonium |
| Flavanoids, | <5%, preferably | quercetin, kaempferol, myricetin, fisetin, |
| isoflavanoids, and | <4%, <3%, or <2%, | galangin, isorhamnetin, pachypodol, rhamnazin, |
| neoflavanoids | more preferably | pyranoflavonols, furanoflavonols, luteolin, |
| | <1%, <0.5%, or 0% | apigenin, tangeritin, taxifolin (or |
| | | dihydroquercetin), dihydrokaempferol, |
| | | hesperetin, naringenin, eriodictyol, |
| | | homoeriodictyol, genistein, daidzein, glycitein |
| Flavanoid | <5%, preferably | hesperidin, naringin, rutin, quercitrin, luteolin- |
| glycosides | <4%, <3%, or <2%, | glucoside, quercetin-xyloside |
| | more preferably | |
| | <1%, <0.5%, or 0% | |
| Anthocyanidins | <5%, preferably | cyanidin, delphinidin, malvidin, pelargonidin, |
| | <4%, <3%, or <2%, | peonidin, petunidin |
| | more preferably | |
| | <1%, <0.5%, or 0% | |
| Tannins | <1%, preferably | tannic acid |
| | <0.5%, <0.25%, or | |
| | 0% | |
| Amino acids + | <0.1%, preferably | alanine, arginine, asparagine, aspartic acid, |
| total protein | <0.05%, or 0% | cysteine, glutamine, glutamic acid, glycine, |
| | | histidine, isoleucine, leucine, lysine, methionine, |
| | | phenylalanine, proline, serine, threonine, |
| | | tryptophan, tyrosine, and valine |
| Total Fat | <1%, preferably | monoglycerides, diglycerides, triglycerides |
| | <0.5%, <0.25%, or | |
| | 0% | |
| Monosaccharides, | <1% | glucose, fructose, sucrose, galactose, ribose, |
| disaccharides, and | | trehalose, trehalulose, lactose, maltose, |
| polysaccharides | | isomaltose, isomaltulose, mannose, tagatose, |
| | | arabinose, rhamnose, xylose, dextrose, erythrose, |
| | | threose, maltotriose, panose |
| Sugar alcohols | <1% | glycerol, sorbitol, mannitol, xylitol, maltitol, |
| | | lactitol, erythritol, isomalt, inositol |
| Dietary fiber | <0.1%, preferably | acacia (arabic) gum, agar-agar, algin-alginate, |
| | <0.05% or 0% | arabynoxylan, beta-glucan, beta mannan, |
| | | carageenan gum, carob or locust bean gum, |
| | | fenugreek gum, galactomannans, gellan gum, |
| | | glucomannan or konjac gum, guar gum, |
| | | hemicellulose, inulin, karaya gum, pectin, |
| | | polydextrose, psyllium husk mucilage, resistant |
| | | starches, tara gum, tragacanth gum, xanthan |
| | | gum, cellulose, chitin, and chitosan |
| Steviol glycoside | <55% | stevioside; steviolbioside; rubusoside; 13- and |
| compounds | | 19-SMG; dulcosides A, B, C, D; and |
| | | rebaudiosides A, B, C, D, E, F, I, M, N, O, T |
| Saponins | <2%, preferably | glycosylated ursolic acid and glycosylated |
| | <1%, <0.5%, | oleanolic acid |
| | <0.25%, or 0% | |
| Terpenes other | <2%, preferably | eugenol, geraniol, geranial, alpha-ionone, beta- |
| than saponins and | <1%, <0.5%, | ionone, epoxy-ionone, limonene, linalool, |
| steviol glycoside | <0.25%, or 0% | linalool oxide, nerol, damascenone |
| compounds | | |
| Lipid oxidation | <2%, preferably | Decanone, decenal, nonenal, octenal, heptenal, |
| products | <1%, <0.5%, | hexenal, pentenal, pentenol, pentenone, |
| | <0.25%, or 0% | hexenone, hydroxynonenal, malondialdehyde |
| Polycyclic | <0.1%, preferably | Acenaphthene, Acenaphthylene, Anthracene, |
| Aromatic | <0.05% or 0% | Benzo(a)anthracene, Benzo(a)pyrene, |
| Hydrocarbons | | Benzo(b)fluoranthene, Benzo(ghi)perylene, |
| | | Benzo(k)fluoranthene, Chrysene, |
| | | Dibenzo(a,h)anthracene, Fluoranthene, Fluorene, |
| | | Indeno(1,2,3-cd)pyrene, Naphthalene, |
| | | Phenanthrene, Pyrene |
| Other compounds | <0.1%, preferably | chlorophyll, furans, furan-containing chemicals, |
| | <0.05% or 0% | theobromine, theophylline, and trigonelline |
| | <1%, preferably | saponins |
| | <0.5%, <0.25%, or | |
| | 0% | |

In some aspects, the sensory modifier comprises less than 0.3% (wt) of malonate, malonic acid, oxalate, oxalic acid, lactate, lactic acid, succinate, succinic acid, malate, or malic acid; or less than 0.05% (wt) of pyruvate, pyruvic acid, fumarate, fumaric acid, tartrate, tartaric acid, sorbate, sorbic acid, acetate, or acetic acid; or less than about 0.05% (wt) of chlorophyll.

In some aspects, an aqueous solution prepared by added an effervescent composition described herein to an aqueous solution does not include certain compound above a certain cutoff wt %. For example, the aqueous solution can comprise less than 0.3% (wt) of malonate, malonic acid, oxalate, oxalic acid, lactate, lactic acid, succinate, succinic acid, malate, or malic acid; or less than 0.05% (wt) of pyruvate, pyruvic acid, fumarate, fumaric acid, tartrate, tartaric acid, sorbate, sorbic acid, acetate, or acetic acid; or less than about 0.05% (wt) of chlorophyll.

### Compositions

An effervescent agent together with one or more sensory modifiers can be formulated into a dry solid effervescent composition. For example, a solid composition can be in the form of a tablet, capsule, cube, or powder. The dry solid effervescent composition may be in the form of a powder. The dry solid effervescent composition may be pressed into a tablet or a cube. The dry solid effervescent composition may be contained within a capsule. The dry solid effervescent composition may be in a form selected from the group consisting of a tablet, a capsule, a cube, or a powder.

The effervescent composition can additionally include a sweetener. Suitable sweeteners are known and described in the art. The sweetener can be at least one of a non-caloric sweetener or a caloric sweetener. The sweetener can be any type of sweetener, for example, a sweetener obtained from a plant or plant product, or a physically or chemically modified sweetener obtained from a plant, or a synthetic sweetener. Exemplary sweeteners include steviol glycosides, mogrosides, sucrose, fructose, glucose, erythritol, maltitol, lactitol, sorbitol, mannitol, xylitol, tagatose, trehalose, galactose, rhamnose, cyclodextrin (e.g., α-cyclodextrin, β-cyclodextrin, and γ-cyclodextrin), ribulose, threose, arabinose, xylose, lyxose, allose, altrose, mannose, idose, lactose, maltose, invert sugar, isotrehalose, neotrehalose, palatinose or isomaltulose, erythrose, deoxyribose, gulose, idose, talose, erythrulose, xylulose, psicose, turanose, cellobiose, glucosamine, mannosamine, fucose, fuculose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose and the like), galacto-oligosaccharides, sorbose, ketotriose (dehydroxyacetone), aldotriose (glyceraldehyde), nigero-oligosaccharides, fructooligosaccharides (kestose, nystose and the like), maltotetraose, maltotriol, tetrasaccharides, mannan-oligosaccharides, malto-oligosaccharides (maltotriose, maltotetraose, maltopentaose, maltohexaose, maltoheptaose and the like), dextrins, lactulose, melibiose, raffinose, rhamnose, ribose, sucralose, coupling sugars, soybean oligosaccharides, and combinations thereof. D- or L-configurations can be used when applicable. Suitable sweeteners and aspects thereof are also described in PCT International Publication Nos. WO 2019/071220 and WO 2019/071182 and in US Patent Application Publication Nos. 2019/0223481 and 2019/0223483, each of which is incorporated by reference herein in its entirety.

In some aspects, the effervescent composition can include a steviol glycoside sweetener. Exemplary steviol glycoside sweeteners can include rebaudioside M, rebaudioside N, rebaudioside D, and rebaudioside A. In some aspects, one or more of the steviol glycosides are isolated from Stevia rebaudiana. In some aspects, one or more of the steviol glycoside components are produced by fermentation by an engineered microorganism or produced enzymatically from plant-derived steviol glycosides and further isolated. For example, rebaudioside D and M can be produced by an engineered organism and then isolated to produce a steviol glycoside component of primarily rebaudioside D and rebaudioside M as the predominant steviol glycoside species. In some aspects, one or more of the steviol glycosides are produced by bioconversion by an enzyme and leaf extract.

Rebaudioside M, rebaudioside D, or both, can be present in the steviol glycoside sweetener in a total amount of about 80% (wt) or greater (e.g., RM80), 90% (wt) or greater (e.g., RM90), 95% (wt) or greater (e.g., RM95), or 99% (wt) or greater of a total amount steviol glycosides in the steviol glycoside sweetener or in the composition. Rebaudioside M can be the predominant steviol glycoside in the steviol glycoside sweetener, and can be present, for example, in an amount in the range of about 50% to about 95%, about 70% to about 90%, or about 75% to about 85% of the total amount steviol glycosides in the steviol glycoside sweetener or in the composition. Rebaudioside D can be in an amount less than Rebaudioside M, such as in an amount in the range of about 5% to about 25%, about 10% to about 20%, or about 10% to about 15% of the total amount of steviol glycosides in the steviol glycoside sweetener or in the composition. For example, the sweetener can comprise mostly rebaudioside M and/or D and can include one or more of rebaudioside A, rebaudioside B, or stevioside in an amount of about 5% (wt) or less, about 2% (wt) or less, or about 1% (wt) or less, of a total amount steviol glycosides in the steviol glycoside component.

In some aspects, the effervescent composition contains additives including, but not limited to, carbohydrates, polyols, amino acids and their corresponding salts, poly-amino acids and their corresponding salts, sugar acids and their corresponding salts, nucleotides, organic acids, inorganic acids, organic salts including organic acid salts and organic base salts, inorganic salts, bitter compounds, flavorants and flavoring ingredients, astringent compounds, proteins or protein hydrolysates, surfactants, emulsifiers, weighing agents, gums, antioxidants, colorants, flavonoids, alcohols, polymers and combinations thereof. In some aspects, the additives may serve as a tablet binder to increase tablet strength and aid in forming the tablet. In some aspects, the additives may serve as a foam stabilizer. In some aspects, the additives may serve as an antifoaming agent. In some aspects, the additives may act to improve the temporal and flavor profile of the effervescent composition to provide a composition with a favorable taste when the effervescent composition is added to an aqueous solution. Examples of such ingredients and aspects thereof are PCT International Publication Nos. WO 2019/071220 and WO 2019/071182 and in US Patent Application Publication Nos. 2019/0223481 and 2019/0223483, each of which is incorporated by reference herein in its entirety.

In some aspects the effervescent composition contains a foam stabilizer. The foam stabilizer may be added to the effervescent composition at a concentration such that when the effervescent composition is added water or an aqueous solution the foam produced by the effervescent composition is present on top of the water or aqueous composition for at least 1 minute, at least 2 minutes, at least 3, minutes, at least 4 minutes, at least 5 minutes, or at least 6 minutes. The foam stabilizer may be included in the effervescent composition at a concentration between 0.1 (wt %) and 10.0 (wt)%, between 0.5 (wt)% and 8.0 (wt)%, between 0.75 (wt)% and 6 (wt)%, between 0.5 (wt)% and 5.0 (wt)%, between 0.75 (wt)% and 3.0 (wt)%, or between 1.0 (wt)% and 2.0 (wt)%. The foam stabilizer may be, but is not limited to, α-dextrin (e.g., α-cyclodextrin). The α-dextrin may be included in the effervescent composition at a concentration between 0.1 (wt %) and 10.0 (wt)%, between 0.5 (wt)% and 8.0 (wt)%, between 0.75 (wt)% and 6 (wt)%, between 0.5 (wt)% and 5.0 (wt)%, between 0.75 (wt)% and 3.0 (wt)%, or between 1.0 (wt)% and 2.0 (wt)%.

The effervescent composition comprising an effervescent agent and a sensory modifier can also contain one or more functional ingredients, which provide a real or perceived heath benefit to the composition. Functional ingredients include, but are not limited to, saponins, antioxidants, dietary fiber sources, fatty acids, vitamins, glucosamine, minerals, preservatives, hydration agents, pain relievers, probiotics, prebiotics, weight management agents, osteoporosis management agents, phytoestrogens, long chain primary aliphatic saturated alcohols, phytosterols and combinations thereof. Examples of functional ingredients and aspects thereof are set forth in PCT International Publication Nos. WO 2019/071220 and WO 2019/071182 and in US Patent Application Publication Nos. 2019/0223481 and 2019/0223483, each of which is incorporated by reference herein in its entirety.

In some aspects, the effervescent composition additionally comprises a dry powdered creamer, a vitamin, a mineral, an antacid, an electrolyte, a pain reliever, or combinations thereof. The effervescent composition can comprise at least 1% (wt), at least 5% (wt), at least 10% (wt), at least 15% (wt), at least 20% (wt), at least 25% (wt), or at least 30% (wt) of a dry powdered creamer, vitamin, mineral, antacid, electrolyte, pain reliever, or combinations thereof. The effervescent composition can comprise between 10%-60% (wt), 15%-55% (wt), 20%-50% (wt), or 25% to 45% (wt) of the creamer, vitamin, mineral, antacid, electrolyte, pain reliever, or combinations thereof.

In some aspects, the effervescent composition additionally comprises a coffee creamer, for example a dairy-based or non-dairy dry powdered creamer. The effervescent composition can comprise a non-dairy creamer. Non-dairy creamers are known in the art and available commercials. In some aspects, the non-dairy creamer comprises a lactose-free non-dairy creamer. In some aspects, the non-dairy creamer comprises a powdered coconut milk, a powdered almond milk, a powdered soy milk, a powdered rice milk, or combinations thereof. In some aspects, the creamer is a dairy based creamer, for example, a dry animal milk powdered. The effervescent composition can comprise at least 10% (wt), at least 15% (wt), at least 20% (wt), at least 25% (wt), or at least 30% (wt) of the creamer. The effervescent composition can comprise between 10%-60% (wt), 15%-55% (wt), 20%-50% (wt), or 25% to 45% (wt) of the creamer.

The effervescent composition can further comprise as one or more bulking agents. Suitable “bulking agents” include, but are not limited to, maltodextrin (10 DE, 18 DE, or 5 DE), corn syrup solids (20 or 36 DE), sucrose, fructose, glucose, invert sugar, sorbitol, xylose, ribulose, mannose, xylitol, mannitol, galactitol, erythritol, maltitol, lactitol, isomalt, maltose, tagatose, lactose, inulin, glycerol, propylene glycol, polyols, polydextrose, fructooligosaccharides, cellulose and cellulose derivatives, and the like, and mixtures thereof. Additionally, in accordance with still other aspects, granulated sugar (sucrose) or other caloric sweeteners such as crystalline fructose, other carbohydrates, or sugar alcohol can be used as a bulking agent due to their provision of good content uniformity without the addition of significant calories.

The effervescent composition can further comprise a binding agent. Suitable “binding agents” include, but are not limited to, magnesium stearate, dextrose, sorbitol, xylitol, lactose, polyvinylpyrolidone (PVP), mannitol, polyethylene glycol (PEG), polyols (e.g., sugar alcohols), and the like.

An effervescent composition described herein comprising an effervescent agent together with one or more sensory modifiers can be incorporated in or used to prepare any known edible material or other composition intended to be ingested and/or contacted with the mouth of a human or animal, such as, for example, pharmaceutical compositions, edible gel mixes and compositions, dental and oral hygiene compositions, foodstuffs (e.g., confections, condiments, chewing gum, cereal compositions, baked goods, baking goods, cooking adjuvants, dairy products, and tabletop sweetener compositions), and beverage products (e.g., beverages, beverage mixes, beverage concentrates, etc.). Examples of such compositions and aspects thereof are set forth in PCT International Publication Nos. WO 2019/071220 and WO 2019/071182 and in US Patent Application Publication Nos. 2019/0223481 and 2019/0223483, each of which is incorporated by reference herein in its entirety.

A pharmaceutical composition comprises a pharmaceutically active substance and a pharmaceutically acceptable carrier or excipient material. A dental composition comprises an active dental substance, which improves the aesthetics or health of at least a portion of the oral cavity, and a base material, which is an inactive substance used as a vehicle.

In some aspects, the solid effervescent composition can be encapsulated. The solid effervescent composition can be encapsulated in any material safe for human consumption that provides a structure suitable for encapsulation. The edible material used for encapsulation may comprise at least one of a protein, a polysaccharide, a lipid, or combinations thereof. Suitable encapsulation materials may include, but are not limited to, zein, soy, collagen, gelatin, cellulose derivatives, starch, alginate, pectin, gums, seaweed extracts, chitosan, glycerol, glycerol esters, waxes, sorbitol polyethylene glycols, fatty acids, phospholipids, and the like. In some aspects, the encapsulation material comprises at least one of zein, soy, collagen, gelatin, cellulose derivatives, starch, alginate, pectin, gums, seaweed extracts, chitosan, glycerol, glycerol esters, waxes, sorbitol polyethylene glycols, fatty acids, phospholipids, and combinations thereof. In some aspects, the encapsulation material comprises chocolate or a confectionary coating. In some aspects, the encapsulated solid effervescent composition is in the form of a tablet or a powder.

In some aspects, the encapsulation material encapsulates the solid effervescent composition and at least one of a dry powdered creamer, vitamin, mineral, antacid, electrolyte, pain reliever, or combinations thereof. For example, the solid effervescent composition and at least one of a dry powdered creamer, vitamin, mineral, antacid, electrolyte, pain reliever, or combinations thereof are combined and encapsulated with a material comprising at least one of zein, soy, collagen, gelatin, cellulose derivatives, starch, alginate, pectin, gums, seaweed extracts, chitosan, glycerol, glycerol esters, waxes, sorbitol polyethylene glycols, fatty acids, phospholipids, and combinations thereof. In some aspects, the solid effervescent composition and at least one of a dry powdered creamer, vitamin, mineral, antacid, electrolyte, pain reliever, or combinations thereof are encapsulated in a material comprising chocolate or a confectionary coating. In some aspects, the solid effervescent composition and a dry powdered creamer are encapsulated in a material comprising chocolate, a confectionary coating, or a combination thereof.

The effervescent composition can be a beverage product or can be used to prepare a beverage product. As used herein a “beverage product” includes, but is not limited to, a ready-to-drink beverage, a beverage concentrate, a beverage syrup, frozen beverage, or a powdered beverage. Suitable ready-to-drink beverages include carbonated and non-carbonated beverages. Carbonated beverages include, but are not limited to, enhanced sparkling beverages, cola, lemon-lime flavored sparkling beverage, orange flavored sparkling beverage, grape flavored sparkling beverage, strawberry flavored sparkling beverage, pineapple flavored sparkling beverage, ginger-ale, soft drinks, and root beer. Non-carbonated beverages include, but are not limited to fruit juice, fruit-flavored juice, juice drinks, nectars, vegetable juice, vegetable-flavored juice, sports drinks, energy drinks, enhanced water drinks, enhanced water with vitamins, near water drinks (e.g., water with natural or synthetic flavorants), coconut water, tea type drinks (e.g. black tea, green tea, red tea, oolong tea), coffee, cocoa drink, beverage containing milk components (e.g. milk beverages, coffee containing milk components, cafe au lait, milk tea, fruit milk beverages), beverages containing cereal extracts, smoothies and combinations thereof. Examples of frozen beverages include, but are not limited to, icees, frozen cocktails, daiquiris, pina coladas, margaritas, milk shakes, frozen coffees, frozen lemonades, granitas, and slushees. Beverage concentrates and beverage syrups can be prepared with an initial volume of liquid matrix (e.g., water) and the desired beverage ingredients. Full strength beverages are then prepared by adding further volumes of water. Powdered beverages are prepared by dry mixing all of the beverage ingredients in the absence of a liquid matrix. Full strength beverages are then prepared by adding the full volume of water.

In some aspects, a method of preparing a beverage provided herein includes adding an effervescent composition as described herein to a liquid matrix (e.g., an aqueous solution). The method can further comprise adding one or more sweeteners, additives and/or functional ingredients to the beverage or to the effervescent composition before adding it to the liquid matrix. In still another aspect, a method of preparing a beverage comprises combining a liquid matrix and a solid effervescent composition comprising an effervescent agent and a sensory modifier, wherein the effervescent composition optionally comprises one or more of a sweetener, a dry powdered creamer, a vitamin, a mineral, an antacid, an electrolyte, and a pain reliever.

When the effervescent composition is added to water or an aqueous solution, bubbles are produced in the solution, i.e., the solution effervesces. In some aspects, the bubbles are present for at least 30 seconds, at least 45 seconds, at least 1 minute, at least 2 minutes, at least 3 minutes, or at least 4 minutes after the effervescent composition is added to the aqueous solution. In some aspects, the effervescent composition produces bubbles sufficient to form a foam on the top of the aqueous solution. In some aspects, the foam covers the entire top surface of the aqueous solution. In some aspects, the foam is present on the aqueous solution for at least 30 seconds, at least 45 seconds, at least 1 minute, at least 2 minutes, at least 3 minutes, or at least 4 minutes after the effervescent composition is added to the aqueous solution.

In another aspect, a beverage is prepared using a dry solid effervescent composition containing steviol glycosides, wherein the steviol glycosides are present in the dry solid effervescent composition in an amount such that a beverage prepared therefrom contains steviol glycosides in an amount ranging from about 1 ppm to about 10,000 ppm, such as, for example, from about 25 ppm to about 800 ppm. In another aspect, steviol glycosides are present in the dry solid effervescent composition such that the beverage prepared therefrom comprises steviol glycosides in an amount ranging from about 100 ppm to about 600 ppm. In yet other aspects, steviol glycosides are present the dry solid effervescent composition such that the beverage prepared therefrom comprises steviol glycosides an amount ranging from about 100 to about 200 ppm, from about 100 ppm to about 300 ppm, from about 100 ppm to about 400 ppm, or from about 100 ppm to about 500 ppm. In still another aspect, steviol glycosides are present the dry solid effervescent composition such that the beverage prepared therefrom comprises steviol glycosides an amount ranging from about 300 to about 700 ppm, such as, for example, from about 400 ppm to about 600 ppm. In a particular aspect, steviol glycosides are present the dry solid effervescent composition such that the beverage prepared therefrom comprises steviol glycosides an amount of about 500 ppm.

The present invention can be better understood by reference to the following examples which are offered by way of illustration. The present invention is not limited to the examples given herein.

### EXAMPLES

### Materials and Methods

The tested sensory modifier was a mixture of monocaffeoylquinic and dicaffeoylquinic acids and salts prepared from yerba mate and having a ratio of salt fraction to acid fraction of 65:35. For some of the compositions, the sensory modifier was co-spray dried with a steviol glycoside. Table 3 lists the contents and source of various components.

Solutions were prepared which contained an effervescent agent alone, for use as a control sample, or an effervescent agent together with a sensory modifier. Solutions were prepared by dissolving the effervescent agent and/or sensory modifiers into reverse osmosis water at the indicated concentrations and/or ratios. Some solutions also included a sweetener or other ingredients as indicated in the Examples below.

TABLE 3

| Component | Ingredients | Source |
|---|---|---|
| Steviol Glycoside | ≥85 wt % rebaudioside M | Cargill, Inc. |
| Sweetener | ≈3-15 wt % rebaudioside D | (Wayzata, MN) |
| Sensory Modifier | Mixture containing mono- and | Cargill, Inc. |
| | dicaffeoylquinic acids and salts, | (Wayzata, MN) |
| | prepared from Yerba mate | |
| | 65:35 ratio of salt:acid from | |
| 7:5 Co-spray dry | 7:5 ratio of the steviol glycoside | Cargill, Inc. |
| | sweetener and the sensory modifier | (Wayzata, MN) |

Assays were carried out to characterize the sensory attributes of the effervescent compositions in aqueous solution with various amounts of sensory modifier. Sensory attributes of the solutions were tested by a panel of individuals that are experienced in sensory testing. The experienced panelists assessed flavor attributes such as saltiness, acidity, bitterness, sourness, astringency, and mouth drying. In some Examples, a roundtable methodology was used to assess various flavor attributes. To test each solution, the experienced panelists dispensed approximately 2 mL of each solution into their own mouths by transfer pipet, dispersed the solution by moving their tongues, and recorded a value or comments for the attribute(s) being tested. Between tasting solutions, the panelists were able to cleanse their palates with water.

Assays were carried out to assign a saltiness intensity value to effervescent compositions in aqueous solution with various amounts of sensory modifier. Saltiness intensity values were measured by a panel of individuals that are experienced in sensory testing. The experienced panelists used a standard range of 0.18%, 0.35%, 0.5%, and 0.567% sodium chloride solutions corresponding to saltiness intensity values of 2, 5, 8.5, and 10, respectively as a scale against which to measure saltiness intensity values. To test each solution, the experienced panelists dispensed 3-4 mL of each solution into their own mouths, dispersed the solution by moving their tongues, and individually recorded a salt scale value. Between tasting solutions, the panelists were able to cleanse their palates with water.

### Example 1—Effervescent Composition Aqueous Test Samples

Assays were carried out to characterize sensory attributes of effervescent compositions in an aqueous solution. A saltiness intensity value was determined by a panel of two individuals using a roundtable consensus approach. Panelists were experienced in sensory testing. The panelists used the assay method and standardized sodium chloride solutions described above. The aqueous solutions used in this assay were prepared by dissolving the sodium bicarbonate, citric acid, and, in two tests, a sensory modifier in reverse osmosis water. The effervescent composition formulations and saltiness intensity values are reported in Table 4.

TABLE 4

| | Sodium | Citric | | Saltiness | |
|---|---|---|---|---|---|
| Water | Bicarbonate | Acid | Sensory | Intensity | |
| (wt %) | (wt %) | (wt %) | Modifier | Value | Comments |
| 95.40 | 3.00 | 1.60 | — | 8.5+ | Noticeable saltiness |
| 95.375 | 3.00 | 1.60 | 250 ppm | 5.5-6 | Initial sourness from the citric |
| | | | | | acid, delay in onset of |
| | | | | | saltiness, achieving peak |
| | | | | | saltiness after 3-4 second, |
| | | | | | reduction in saltiness |
| 95.35 | 3.00 | 16.0 | 500 ppm | 5 | Slightly further delay in onset, |
| | | | | | subtle further reduction in |
| | | | | | saltiness intensity, slight |
| | | | | | astringent/mouth drying |

### Example 2—Effervescent Sports Hydration Tablet

Assays were carrier out to characterize sensory attributes of effervescent sports hydration tablets. A saltiness intensity value was determined by a panel of two individuals using a roundtable consensus approach. Panelists were experienced in sensory testing. The panelists used the assay method and standardized sodium chloride solutions described above. The effervescent compositions used in this assay were prepared by dissolving an orange flavored effervescent sports hydration tablet commercially available from CVS Health™ either alone or with a sensory modifier into reverse osmosis water. The commercially available effervescent sports hydration tablet provided a final concentration of about 0.25 wt % sodium bicarbonate and about 0.52 wt % citric acid in the resulting aqueous solution. The effervescent composition formulations and saltiness intensity values are reported in Table 5.

TABLE 5

| | Effervescent Sports | | | |
|---|---|---|---|---|
| | Hydration Tablet - | | | |
| Water | Orange Flavored | Sensory | Salt | |
| (wt %) | (wt %) | Modifier | Scale | Comments |
| 99.020 | 0.980 | — | 2+ | Initial citric acid and salty notes, |
| | | | | delayed onset and low intensity |
| | | | | of orange flavor, slight (3 on a |
| | | | | scale of 1-6) bitter after taste |
| 98.995 | 0.980 | 100 ppm | Less than 2 | Orange flavor onset perceived |
| | | | | earlier, noticeable delay in salty |
| | | | | onset, faint (2 on a scale of 1-6) |
| | | | | bitter after taste |

### Example 3—Effervescent Composition

Assays were carried out to assign a salt scale value to effervescent compositions in aqueous solution with and without a sensory modifier. Sensory attributes of the solutions were tested by a panel of eight individuals that are experienced in sensory testing. The panelists used the assay method and standardized sodium chloride solutions described above. The effervescent compositions used in this assay were prepared by dissolving sodium bicarbonate and citric acid, with or without a sensory modifier into reverse osmosis water. The effervescent composition formulations and average saltiness intensity values are reported in Table 6.

TABLE 6

| | Sodium | Citric | | Average | |
|---|---|---|---|---|---|
| Water | Bicarbonate | Acid | Sensory | Saltiness | |
| (wt %) | (wt %) | (wt %) | Modifier | Intensity | Comments |
| 95.40 | 3.00 | 1.60 | — | 7.7 | Quickly perceived saltiness |
| 95.375 | 3.00 | 1.60 | 250 ppm | 6.5 | Milder saltiness, delayed salty |
| | | | | | onset |

### Example 4—Exemplary Effervescent Coffee Creamer Compositions

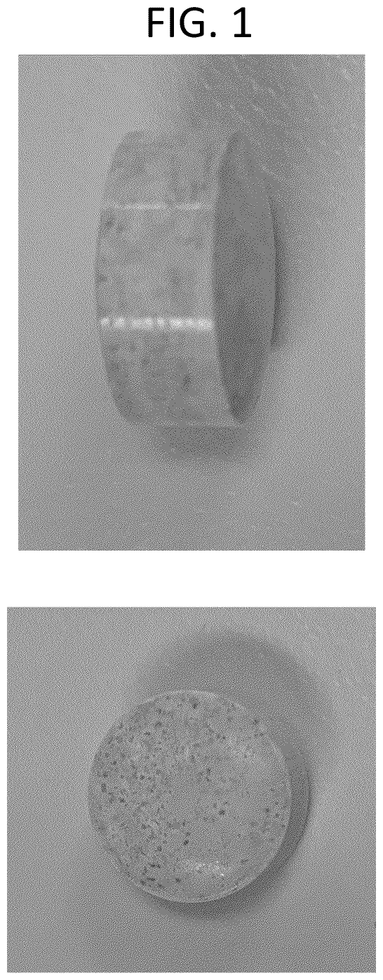

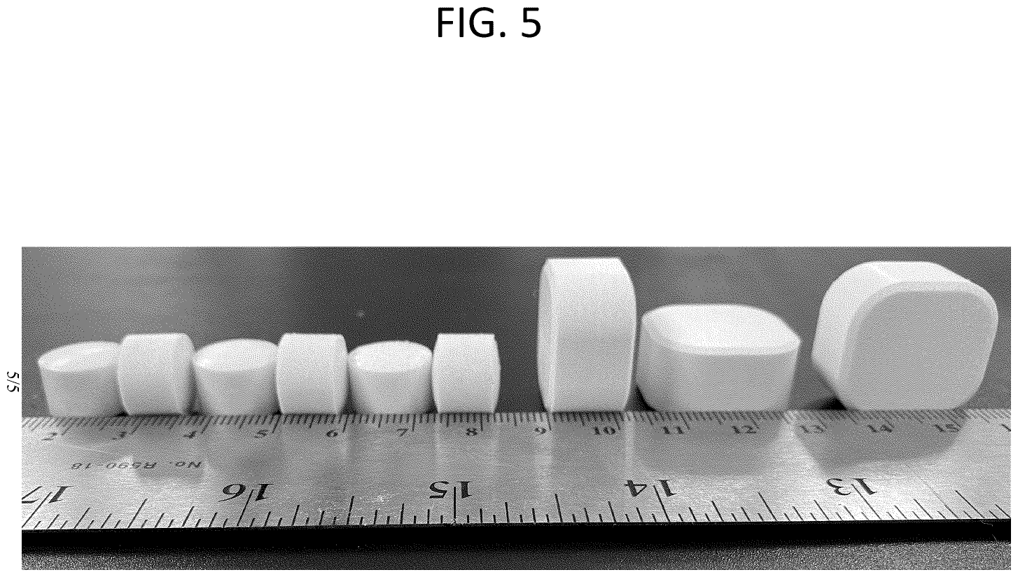

Table 7 includes four exemplary effervescent coffee creamer compositions. The effervescent agent used in these compositions included a 50:50 ratio of sodium bicarbonate and citric acid. The non-dairy coffee creamer was a commercially available dry powdered coffee creamer available from Coffee-Mate™. The steviol glycoside and sensory modifier were added as a co-spray dried composition with a 7:5 ratio of steviol glycoside to sensory modifier as outlined in Table 3. Table 7 reports the final weight percentage of the steviol glycoside and sensory modifier in the composition. Some of the effervescent formulations also included a flavor, e.g., a vanilla flavor. Each of the effervescent coffee creamer compositions were formed into a 1.5 g tablet and/or a 6 g cube suitable for use in a beverage, for example, a coffee beverage. Pictures of the 1.5 g effervescent coffee creamer tablet are provided in FIG. 1 and a comparison of the 1.5 G tablet and the 6 g cube is provided in FIG. 5.

When placed into 8 oz. of hot coffee, the effervescent coffee creamer tablets or cubes disintegrated and dissolved. Bubbles formed and resulted in a foam on the top of the coffee beverage.

TABLE 7

| | Sodium | | | | |
|---|---|---|---|---|---|
| | Bicarbonate:Citric | Non-dairy | | Steviol | Sensory |
| | Acid (50:50) | creamer | Flavor | Glycoside | Modifier |
| | (wt %) | (wt %) | (wt %) | (wt %) | (wt %) |
| A | 60.00 | 29.40 | 0.30 | 6.00 | 4.30 |
| B | 50.00 | 39.52 | 0.18 | 6.00 | 4.30 |
| C | 60.00 | 29.40 | 0.30 | 6.00 | 4.30 |
| D | 60.00 | 29.52 | 0.18 | 6.00 | 4.30 |
| E | 50.00 | 39.70 | 0 | 6.00 | 4.30 |
| F | 50.00 | 39.20 | 0.50 | 6.00 | 4.30 |
| G | 45.00 | 44.40 | 0.30 | 6.00 | 4.30 |
| H | 40.00 | 49.40 | 0.30 | 6.00 | 4.30 |
| I | 35.00 | 54.40 | 0.30 | 6.00 | 4.30 |
| J | 30.00 | 59.40 | 0.30 | 6.00 | 4.30 |
| K | 25.00 | 64.40 | 0.30 | 6.00 | 4.30 |
| L | 20.00 | 69.40 | 0.30 | 6.00 | 4.30 |

### Example 5—Exemplary Encapsulated Effervescent Coffee Creamer Compositions

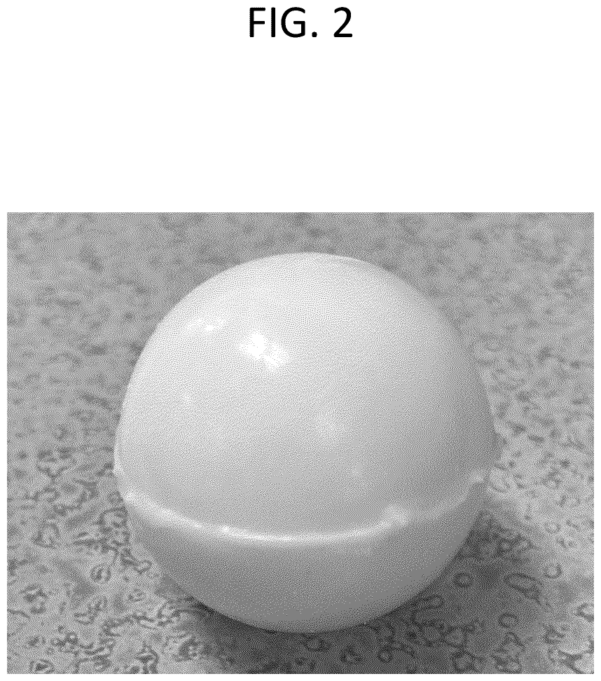

An encapsulated effervescent coffee creamer composition is shown in FIG. 2. The encapsulated effervescent coffee creamer was prepared using effervescent coffee creamer tablets described in Example 4. To form the encapsulated composition, tablet B of Example 4 was combined with 1 g of dry powdered non-dairy creamer commercially available from Coffee-Mate™. The resulting composition was then encapsulated in a confectionary coating containing commercially available from Wilbur™ Chocolate. The final weight of the encapsulated composition was about 9 g-9.5 g.

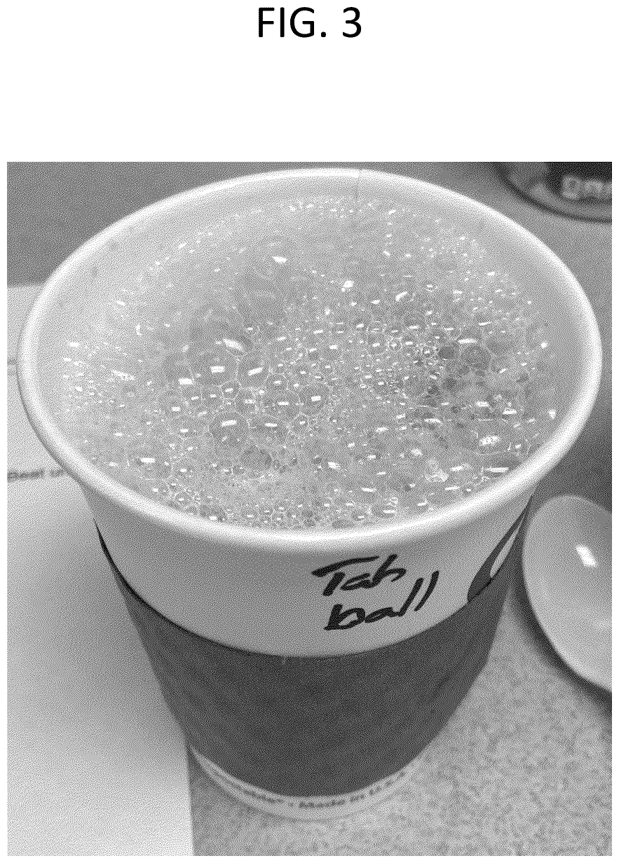

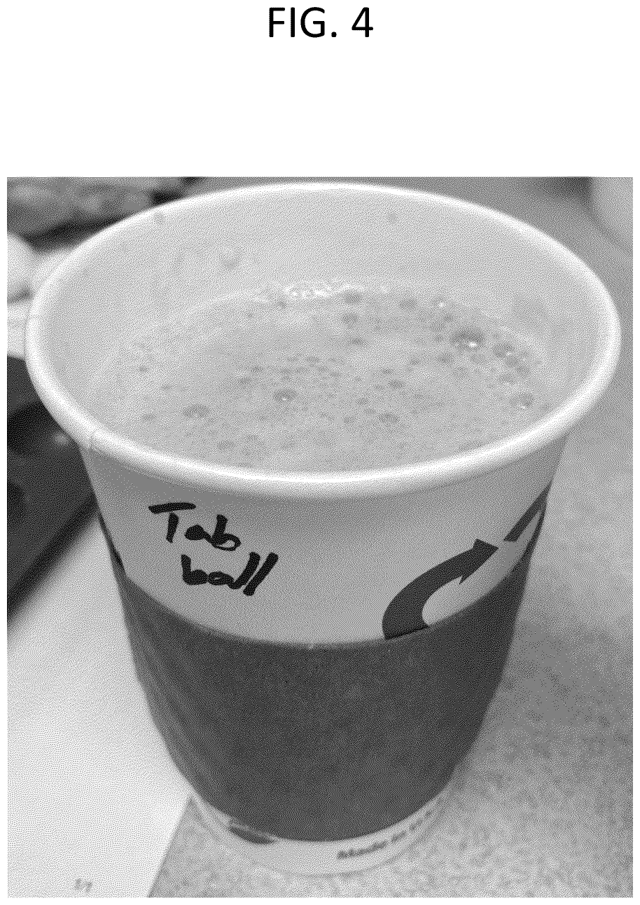

FIGS. 3 and 4 show a coffee beverage prepared using the encapsulated effervescent coffee creamer composition. The coffee beverage was prepared by added the encapsulated effervescent coffee creamer composition to 8 oz. of hot coffee. FIG. 3 shows the coffee immediately after dissociation of the capsule and release of the effervescent agent. As shown, a heavy, tall foam is formed on top of the coffee bubble. After about 1 minute, the foam has dissipated and fallen, but is still visible on top of the coffee beverage, as shown in FIG. 4.

1. A solid effervescent composition, the composition comprising
an effervescent agent comprising an acid and a base; and
a sensory modifier comprising:
a dicaffeoylquinic acid or salt thereof; and
one or more compounds selected from the group consisting of
monocaffeoylquinic acids, monoferuloylquinic acids, diferuloylquinic acids,
monocoumaroylquinic acids, dicoumaroylquinic acids, and salts thereof.

2. The composition of claim 1, wherein when the composition is added in water or an aqueous solution, saltiness of the resulting solution is reduced relative to saltiness of an aqueous solution prepared with an equivalent composition lacking the sensory modifier.

3. The composition of claim 1, wherein when the composition is added in water, a saltiness intensity value of the resulting solution is reduced by at least 1 unit relative to a saltiness intensity value of an aqueous solution prepared with an equivalent composition lacking the sensory modifier, wherein saltiness intensity value is measured by the Standardized Saltiness Intensity Test.

4. (canceled)

5. The composition of claim 1, wherein the effervescent composition is in the form of a tablet, a cube, or a powder.

6.-8. (canceled)

9. The composition of claim 1, wherein the composition comprises between 20%-70% (wt) of the effervescent agent.

10. The composition of claim 1, wherein the effervescent agent comprises a 0.25:1 to 3:1 ratio of acid to base.

11. The composition of claim 1, wherein the base of the effervescent agent is selected from the group consisting of potassium bicarbonate, sodium bicarbonate, sodium carbonate, sodium sesquicarbonate, potassium carbonate, magnesium carbonate, calcium carbonate, and combinations thereof, and wherein the acid of the effervescent agent is selected form the group consisting of citric acid, aspartic acid, malic acid, adipic acid, tartaric acid, fumaric acid, succinic acid, sodium acid pyrophosphate, lactic acid, hexamic acid, amino acid hydrochlorides, acid salts thereof, acid anhydrides thereof, and combinations thereof.

12. (canceled)

13. The composition of claim 1, wherein the at least 1% (wt) of the composition.

14. The composition of claim 1, wherein the sensory modifier is 2%-8% (wt) of the composition.

15. The composition of claim 1, wherein the dicaffeoylquinic acid or dicaffeoylquinic salt comprises at least one compound selected from the group consisting of 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, 4,5-dicaffeoylquinic acid, and salts thereof, and wherein the sensory modifier comprises a monocaffeoylquinic component selected from the group consisting of chlorogenic acid, neochlorogenic acid, cryptochlorogenic acid, and salts thereof.

16. The composition of claim 1, wherein the total of all dicaffeoylquinic acids and dicaffeoylquinic salts present in the sensory modifier comprises 20% (wt) or more of a total weight of the sensory modifier.

17. (canceled)

18. The composition of claim 1, wherein the sensory modifier comprises a monocaffeoylquinic component and a dicaffeoylquinic component that together comprise more than 80% (wt) of the sensory modifier.

19. The composition of claim 1, wherein the composition additionally comprises a sweetener.

20.-21. (canceled)

22. The composition of claim 1, additionally comprising at least one of rebaudioside A, rebaudioside B, rebaudioside D, and rebaudioside M.

23. (canceled)

24. The composition of claim 1, wherein the composition additionally comprises a dry powdered creamer, a vitamin, a mineral, an antacid, an electrolyte, a pain reliever, or combinations thereof.

25.-27. (canceled)

28. The composition of claim 1, wherein the composition comprises between 10%-60% (wt) of a dry powdered creamer.

29. The composition of claim 28, wherein the creamer comprises a non-dairy creamer.

30. (canceled)

31. The composition of claim 28, wherein the non-dairy creamer comprises a powdered coconut milk, a powdered almond milk, a powdered soy milk, a powdered rice milk, a dry animal milk powder, or combinations thereof.

32.-39. (canceled)

40. A beverage product comprising the composition of claim 1.

41. A dry powdered beverage comprising the composition of claim 1.

42. A solid effervescent composition, the composition comprising
at least 20% (wt) of an effervescent agent comprising an acid and a base; and
at least 1% (wt) a sensory modifier comprising
a dicaffeoylquinic acid or salt thereof; and
one or more compounds selected from the group consisting of
monocaffeoylquinic acids, monoferuloylquinic acids, diferuloylquinic acids,
monocoumaroylquinic acids, dicoumaroylquinic acids, and salts thereof,
wherein when the composition is added in water or an aqueous solution, saltiness of the resulting solution is reduced relative to saltiness of an aqueous solution prepared with an equivalent composition lacking the sensory modifier.

43. The composition of claim 42, wherein when the composition is added in water, a saltiness intensity value of the resulting solution is reduced by at least 1 unit relative to a saltiness intensity value of an aqueous solution prepared with an equivalent composition lacking the sensory modifier, wherein saltiness intensity value is measured by the Standardized Saltiness Intensity Test.

44. (canceled)

45. The composition of claim 42, wherein the effervescent composition is in the form of a tablet, a cube, or a powder.

46.-49. (canceled)

50. The composition of claim 42, wherein the effervescent agent comprises a 0.25:1 to 3:1 ratio of acid to base.

51. The composition of claim 42, wherein the base of the effervescent agent is selected from the group consisting of potassium bicarbonate, sodium bicarbonate, sodium carbonate, sodium sesquicarbonate, potassium carbonate, magnesium carbonate, calcium carbonate, and combinations thereof, and wherein the acid of the effervescent agent is selected form the group consisting of citric acid, aspartic acid, malic acid, adipic acid, tartaric acid, fumaric acid, succinic acid, sodium acid pyrophosphate, lactic acid, hexamic acid, amino acid hydrochlorides, acid salts thereof, acid anhydrides thereof, and combinations thereof.

52.-54. (canceled)

55. The composition of claim 42, wherein the dicaffeoylquinic acid or dicaffeoylquinic salt comprises at least one compound selected from the group consisting of 1,3-dicaffeoylquinic acid, 1,4-dicaffeoylquinic acid, 1,5-dicaffeoylquinic acid, 3,4-dicaffeoylquinic acid, 3,5-dicaffeoylquinic acid, 4,5-dicaffeoylquinic acid, and salts thereof, and wherein the sensory modifier comprises a monocaffeoylquinic component selected from the group consisting of chlorogenic acid, neochlorogenic acid, cryptochlorogenic acid, and salts thereof.

56. The composition of claim 42, wherein the total of all dicaffeoylquinic acids and dicaffeoylquinic salts present in the sensory modifier 20% (wt) or more a total weight of the sensory modifier, and wherein the sensory modifier comprises a monocaffeoylquinic component and a dicaffeoylquinic component that together comprise more than 80% (wt) of the sensory modifier.

57.-78. (canceled)

79. The beverage of claim 40, wherein the beverage is a coffee beverage.

80.-81. (canceled)

82. A method of preparing a beverage product with reduced saltiness, the method comprising:
adding an effervescent agent and a sensory modifier to an aqueous solution to form a beverage product, wherein the effervescent composition comprises an acid and a base and the sensory modifier comprises (i) a dicaffeoylquinic acid or salt thereof, and (ii) one or more compounds selected from the group consisting of monocaffeoylquinic acids, monoferuloylquinic acids, diferuloylquinic acids, monocoumaroylquinic acids, dicoumaroylquinic acids, and salts thereof,
wherein saltiness of the beverage composition is reduced relative to saltiness of a beverage prepared with an equivalent effervescent composition lacking the sensory modifier.

83. The method of claim 82, wherein the beverage product additionally comprises a sweetener, a flavor, a functional ingredient, or combinations thereof.

84. The method of claim 82, wherein the beverage product comprises 25 ppm to 800 ppm of steviol glycoside, 1 ppm to 2000 ppm of the sensory modifier, and a creamer.

85.-133. (canceled)
